(19) United States
(12) Patent Application Publication
(10) Pub. No.: US 2021/0209552 A1
(43) Pub. Date: Jul. 8, 2021

(54) ELECTRONIC BUSINESS CARD MANAGEMENT METHOD AND APPARATUS

(71) Applicant: Dingtalk Holding (Cayman) Limited, Grand Cayman (KY)

(72) Inventors: Shangmingxue Kang, Hangzhou (CN); Rongjun Wang, Hangzhou (CN); Yutong Liu, Hangzhou (CN); Chengyu Zhang, Hangzhou (CN); Qianzi Xiong, Hangzhou (CN); Hang Ma, Hangzhou (CN); Jie Niu, Hangzhou (CN); Feng Luo, Hangzhou (CN)

(21) Appl. No.: 17/207,386

(22) Filed: Mar. 19, 2021

Related U.S. Application Data
(63) Continuation of application No. PCT/CN2019/106634, filed on Sep. 19, 2019.

(30) Foreign Application Priority Data
Sep. 21, 2018 (CN) 201811105704.X
Nov. 27, 2018 (CN) 201811425334.8

(51) Int. Cl. G06Q 10/10; G06F 21/62

(52) U.S. Cl. CPC G06Q 10/10; G06F 21/6218

(57) ABSTRACT

A method including acquiring an electronic business card; determining corresponding scene information when the electronic business card is acquired; and associating the electronic business card with the corresponding scene information.

### CROSS REFERENCE TO RELATED APPLICATIONS

This application claims priority to and is a continuation of PCT Patent Application No. PCT/CN2019/106634, filed on 19 Sep. 2019 and entitled “ELECTRONIC BUSINESS CARD MANAGEMENT METHOD AND APPARATUS,” which claims priority to Chinese patent application No. 201811425334.8 filed on Nov. 27, 2018 and titled “ELECTRONIC BUSINESS CARD MANAGEMENT METHOD AND APPARATUS,” and Chinese patent application No. 201811105704.X filed on Sep. 21, 2018, which are incorporated by reference herein in their entirety.

### TECHNICAL FIELD

The present disclosure relates to the field of terminal technologies, and, more particularly, to an electronic business card management method and apparatus.

### BACKGROUND

Business cards are used to show names, affiliated organization information, contact information, and the like of users, and may assist the users to enhance mutual understanding quickly. Traditional business cards are in the form of a physical card and the above information is printed on the cards. With the continuous development of electronic technologies, various information on business cards may be entered as electronic information, thereby forming electronic business cards that can be stored and recorded on electronic devices. In this way, materials such as paper consumed during production of traditional business cards can be saved; further, users do not need to keep business cards with them. Exchanging electronic business cards among the users becomes fast and easy.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above, one or more embodiments of the present disclosure provide an electronic business card management method and apparatus.

To achieve the above-described objective, one or more embodiments of the present disclosure provide the following technical solutions.

According to an embodiment of the present disclosure, an electronic business card management method is provided, comprising:
acquiring an electronic business card;
determining corresponding scene information when the electronic business card is acquired; and
associating the electronic business card with the corresponding scene information.

According to an embodiment of the present disclosure, an electronic business card management method is provided, comprising:
determining electronic business cards acquired by members in an organization;
recording a relationship between the electronic business cards and the organization; and
setting access permissions for the members in the organization for the electronic business cards according to the relationship.

According to an embodiment of the present disclosure, an electronic business card management method is provided, comprising:
determining a selected electronic business card; and
displaying, on a content display interface of the electronic business card, personal introduction information of a target user corresponding to the electronic business card and organization introduction information of an organization with which the target user is affiliated.

According to an embodiment of the present disclosure, an electronic business card management method is provided, comprising:
receiving, from a first user, a business card access request, wherein the business card access request is initiated for an electronic business card shared by a second user; and
returning to the first user content of the electronic business card, wherein when the first user has not acquired an access permission granted by the second user, at least some of the content of the electronic business card is in a state hidden from the first user.

According to an embodiment of the present disclosure, an electronic business card management apparatus is provided, comprising:
a business card acquiring unit, configured to acquire an electronic business card;
a scene determination unit, configured to determine corresponding scene information when the electronic business card is acquired; and
an association and storage unit, configured to associate the electronic business card with the corresponding scene information.

According to an embodiment of the present disclosure, an electronic business card management apparatus is provided, comprising:
a business card determination unit, configured to determine electronic business cards acquired by members in an organization;
a relationship recording unit, configured to record a relationship between the electronic business cards and the organization; and
a first permission granting unit, configured to set access permissions for the members in the organization for the electronic business cards according to the relationship.

According to an embodiment of the present disclosure, an electronic business card management apparatus is provided, comprising:
a business card determination unit, configured to determine a selected electronic business card; and
a first display unit, configured to display, on a content display interface of the electronic business card, personal introduction information of a target user corresponding to the electronic business card and organization introduction information of an organization with which the target user is affiliated.

According to an embodiment of the present disclosure, an electronic business card management apparatus is provided, comprising:
a first receiving unit, configured to receive, from a first user, a business card access request, wherein the business card access request is initiated for an electronic business card shared by a second user; and
a returning unit, configured to return to the first user content of the electronic business card, wherein when the first user does not acquire an access permission granted by the second user, at least some of the content of the electronic business card is in a state hidden from the first user.

### BRIEF DESCRIPTION OF DRAWINGS

To describe the technical solutions in the embodiments of the present disclosure more clearly, the following briefly describes the accompanying drawings for describing the embodiments. Apparently, the accompanying drawings in the following description merely represent some and not all of the embodiments of the present disclosure, and a person of ordinary skill in the art may still derive other accompanying drawings from these accompanying drawings without creative efforts.

FIG. 1 is a schematic architecture diagram of an electronic business card management system according to an example embodiment;

FIG. 2 is a flowchart of an electronic business card management method according to an example embodiment I;

FIG. 3 is a flowchart of an electronic business card management method according to example embodiment II;

FIG. 4 is a flowchart of an electronic business card management method according to example embodiment III;

FIG. 5 is a schematic diagram of a function trigger interface according to an example embodiment;

FIG. 6 is a schematic diagram of an interaction interface for device-to-device business cards exchanging according to an example embodiment;

FIG. 7 is a schematic diagram of an interface for displaying a result of device-to-device business cards exchanging according to an example embodiment;

FIG. 8 is a schematic diagram of a business card folder interface according to an example embodiment;

FIG. 9 is a schematic diagram of performing an operation on an electronic business card according to an example embodiment;

FIG. 10 is a schematic diagram of a batch operation interface according to an example embodiment;

FIG. 11 is a schematic diagram of an annotation and label editing interface according to an example embodiment;

FIG. 12 is a schematic diagram of a label setting interface according to an example embodiment;

FIG. 13A is a schematic diagram of a business card sharing interface according to an example embodiment;

FIG. 13B is a schematic diagram of applying for a business card access permission according to an example embodiment;

FIG. 13C is a schematic diagram of reviewing a permission acquiring request according to an example embodiment;

FIG. 14 is a schematic diagram of a business card details interface according to an example embodiment;

FIG. 15 is a schematic diagram of recording contact information according to an example embodiment;

FIG. 16 is a schematic diagram of exchanging electronic business cards across applications according to an example embodiment;

FIG. 17 is a schematic diagram of viewing content of an electronic business card according to an example embodiment;

FIG. 18 is a schematic diagram of cross-application authorization according to an example embodiment;

FIG. 19 is a schematic structural diagram of a device according to the example embodiment I;

FIG. 20 is a block diagram of an electronic business card management apparatus according to the example embodiment I;

FIG. 21 is a schematic structural diagram of a device according to the example embodiment II;

FIG. 22 is a block diagram of an electronic business card management apparatus according to the example embodiment II;

FIG. 23 is a schematic structural diagram of a device according to the example embodiment III;

FIG. 24 is a block diagram of an electronic business card management apparatus according to the example embodiment III;

FIG. 25 is a flowchart of an electronic business card management method according to an example embodiment IV;

FIG. 26 is a schematic structural diagram of a device according to the example embodiment IV; and

FIG. 27 is a block diagram of an electronic business card management apparatus according to the example embodiment IV.

### DETAILED DESCRIPTION

Example embodiments are described below in detail, and examples thereof are illustrated in the accompanying drawings. When the following description refers to the accompanying drawings, unless otherwise indicated, the same numbers in different accompanying drawings indicate the same or similar elements. Implementation manners described in the following example embodiments do not represent all implementation manners consistent with one or more embodiments of the present disclosure. On the contrary, the implementation manners are merely examples of apparatuses and methods consistent with some aspects of one or more embodiments of the present disclosure as detailed in the appended claims.

It should be noted that in other embodiments, steps of a corresponding method may not be performed in an order shown and described in the present disclosure. In some other embodiments, the method may include more or fewer steps than those described in the present disclosure. In addition, a single step described in the present disclosure may be split into more steps and described in other embodiments; and more steps described in the present disclosure may also be combined into a single step and described in other embodiments.

In an embodiment, an electronic business card management solution of the present disclosure may be applied to an electronic device. For example, the electronic device may include a mobile phone, a tablet device, a notebook computer, a personal digital assistant (PDA), a wearable device (such as smart glasses or a smart watch), and any other type, which is not limited by the present disclosure. During operation, the electronic device may perform a related management operation on an electronic business card independently or in combination with another electronic device, so as to implement the electronic business card management solution of the present disclosure.

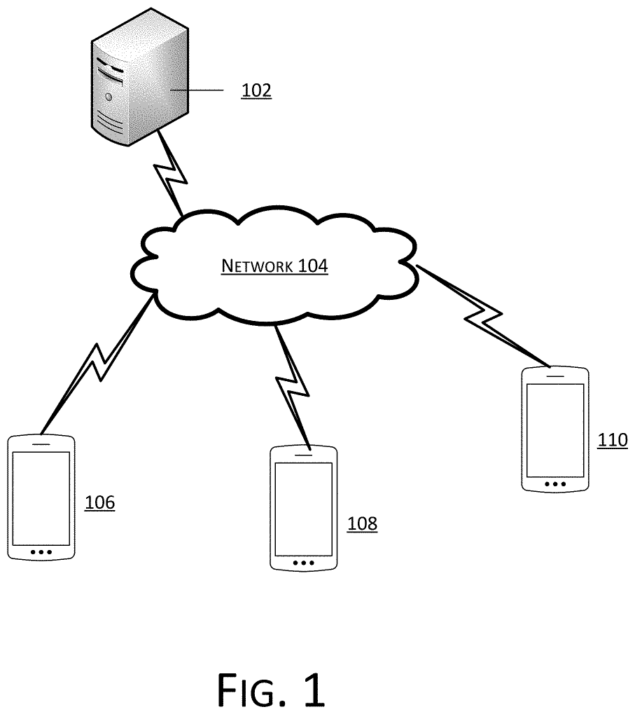

FIG. 1 is a schematic architecture diagram of a call prompting system according to an example embodiment. As shown in FIG. 1, the system may include a server 102, a network 104, and several electronic devices, such as a mobile phone 106, a mobile phone 108, a mobile phone 110, etc.

The server 102 may be a physical server including an independent host, or a virtual server hosted by a host cluster. During operation, the server 102 may run a server-side program of an application to implement related service functions of the application. For example, when the server 102 runs a program of a mobile workspace platform for an organization, it may be implemented as a server for the mobile workspace platform of the organization. However, in technical solutions of one or more embodiments of the present disclosure, the server 102 may cooperate with clients running on the mobile phones 106 to 110 to implement a management solution for electronic business cards.

In this embodiment, a mobile workspace platform for organizations may implement not only a communication function, but it may also serve as an integrated functional platform for many other functions. For example, it may serve to process events within an organization like reviewing and approval events (such as review and approval of time-off requests, office supply requests, or requests related to financial affairs), attendance events, task events, log events, and the like. It may also serve to process events outside the organization, such as meal ordering or purchasing, which is not limited by one or more embodiments of the present disclosure.

More specifically, the mobile workspace platform for organizations may be hosted by an instant messaging application in a related technology. An example of such a technology is Enterprise Instant Messaging (EIM) application, such as Skype For Business®, Microsoft Teams®, Yammer®, Workplace®, Slack®, Enterprise WeChat®, Fxiaoke®, Enterprise Fetion®, or Enterprise Yixin®. Certainly, an instant messaging function is only one of the communication functions supported by the mobile workspace platform for organizations. The mobile workspace platform for organizations may further implement other different functions in addition to those mentioned above. Details are not elaborated herein.

The mobile phones 106 to 110 are just one type of electronic devices that users may use. In reality, users may certainly also use, for example, the following types of electronic devices: a tablet device, a notebook computer, a personal digital assistant (PDA), a wearable device (such as smart glasses or a smart watch), and the like, which is not limited by one or more embodiments of the present disclosure. During operation, the electronic device may run a client-side program of an application to implement related service functions of the application. For example, when the electronic device runs a program of a mobile workspace platform for an organization, it may be implemented as a client for the mobile workspace platform of the organization.

It should be pointed out that an application program of the client for the mobile workspace platform of the organization may be pre-installed on the electronic device, so that the client may be started and run on the electronic device. Certainly, when the HTML5 technology such as an online “client” is used, the client may be obtained and run without having to install a corresponding application program on the electronic device.

The network 104 used for interaction among the mobile phones 106 to 110 and the server 102 may include various types of wired or wireless networks. In an embodiment, the network 104 may include a public switched telephone network (PSTN) and the Internet.

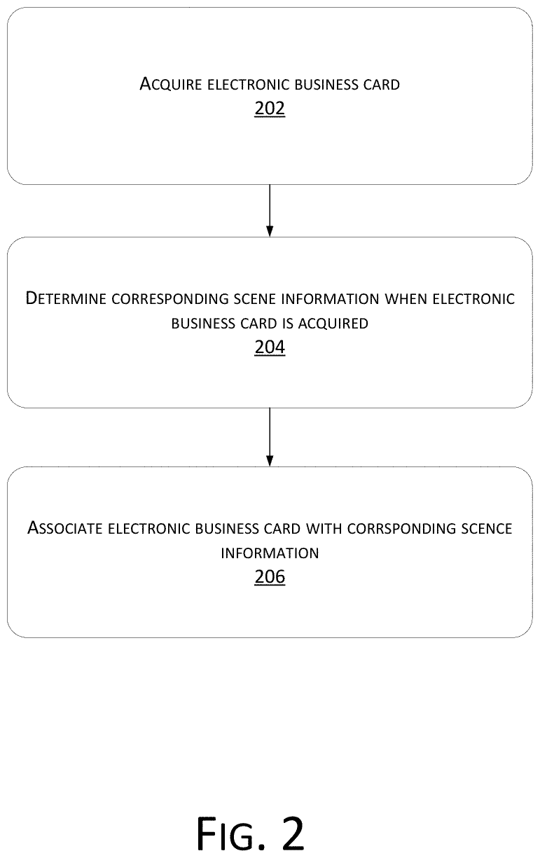

FIG. 2 is a flowchart of an electronic business card management method according to example embodiment I. As shown in FIG. 2, the method is applied to an electronic device (such as the mobile phones 106 to 110 shown in FIG. 1), and may include the following steps:

Step 202. Acquire an electronic business card.

In an embodiment, the electronic business card may include virtual information for realizing a business card function. The information content of the electronic business card may be formed by combining one or more types of a text, a picture, an audio, a video, and the like, which is not limited by the present disclosure.

In an embodiment, the electronic business card may be acquired in any manner, which is not limited by the present disclosure.

For example, the electronic device may receive an electronic business card proactively sent by an adjacent electronic device. In other words, the operation of sending the electronic business card may be triggered and implemented unilaterally. For another example, the electronic device may proactively send an electronic business card of a local user to the adjacent electronic device, and receive an electronic business card returned by the adjacent electronic device. In other words, electronic business cards are to be sent to each other based on an exchange principle.

Here, sending electronic business cards between the electronic device and the adjacent electronic device may be implemented in various manners. For example, the electronic device may establish a near field communication connection with the adjacent electronic device based on Bluetooth, Wi-Fi, or the like, or the electronic device may establish a remote communication connection with the adjacent electronic device (for example, based on a mobile communication technology such as 4G or 5G). In this way, the electronic device may acquire an electronic business card through the near field communication connection or the remote communication connection. In the technical solution based on the remote communication connection, the electronic device may proactively request for an electronic business card from the adjacent electronic device, or the adjacent electronic device may proactively send an electronic business card to the electronic device, or a server may proactively push an electronic business card of the adjacent electronic device to the electronic device when determining that the electronic device is geographically close to the adjacent electronic device (for example, the determination may be performed based on GPS positioning data, based on a connected Wi-Fi hotspot when the location of the Wi-Fi hotspot is known, or based on a nearby Bluetooth beacon when the location of the Bluetooth beacon is known).

For another example, an electronic business card of a user having logged onto the adjacent electronic device may be acquired from the adjacent electronic device or the server based on a verification code related to the adjacent electronic device. For example, after the adjacent electronic device generates a verification code related to sharing the electronic business card, the local user may enter the verification code on the electronic device, or the electronic device may directly scan the verification code. Then the electronic device may send a verification request including the verification code to the adjacent electronic device or the server. After the adjacent electronic device or the server performs verification and the verification is successful, the electronic business card of the user having logged onto the adjacent electronic device is acquired. In this way, randomly sending electronic business cards may then be confined.

In an embodiment, the electronic device may create a corresponding electronic business card based on a result of scanning information on a paper business card. For example, the electronic device may scan the paper business card (i.e., a traditional business card, the material of which may also be plastic or any other material, which is not limited to paper) by using a camera, so as to recognize content of the business card based on an optical character recognition (OCR) technology and the like, organize the recognition result in a preset format, and create an electronic business card for the local user.

Step 204. Determine corresponding scene information when the electronic business card is acquired.

In an embodiment, the scene information may include at least one of the following: a time, a location, a pre-planned event related to the time, a pre-planned event related to the location, a pre-planned event related to the time and the location, and the like, which is not limited by the present disclosure.

The pre-planned event may include any event preset or pre-planned by the local user, such as schedule planning or an item to be reminded, which is not limited by the present disclosure. For example, when the schedule planning includes “planning related to contacting staff of the enterprise AA on project X at 2 p.m. on September 18”, if an electronic business card is acquired near 2 p.m. (for example, within half an hour before or after 2 p.m.) on September 18, it may be considered that the electronic business card is likely to be related to the above-mentioned schedule planning; and said schedule planning may be acquired as the scene information corresponding to the electronic business card. For another example, when the item to be reminded includes “discussing project Y in hotel XX”, if GPS positioning information of the electronic device shows that the electronic device is at the hotel XX when the electronic business card is acquired, it may be considered that the electronic business card is likely to be related to the above-mentioned item to be reminded. Then said item to be reminded may be acquired as the scene information corresponding to the electronic business card.

Step 206. Associate the electronic business card with the corresponding scene information.

In an embodiment, the electronic business card is associated with the corresponding scene information. Thus, even if a user cannot remember where or when an electronic business card is acquired after a long period of time, when viewing the electronic business card, the user may recall memories related thereto according to the associated scene information. Or the user may quickly locate the corresponding electronic business card according to the scene information, thereby assisting the user in efficiently finalizing events related to the target user.

In an embodiment, the electronic business card and the corresponding scene information may be associated with an organization with which the local user is affiliated. Although the local user acquires the electronic business card, the association enables the electronic business card to be decoupled from the local user and is further associated with the organization with which the local user is affiliated. This way, all members in the organization may (the members may need to meet a certain additional condition, for example, being in the same department with the local user, or having an administration authority higher than that of the local user) acquire an access permission for the electronic business card. Therefore, even if the local user leaves the organization, other members in the organization can still acquire the electronic business card. In other words, the association enables the electronic business card to be deposited into the organization with which the local user is affiliated.

In an embodiment, a permission acquiring request for the electronic business card initiated by any member in the organization may be received. When the any member has not acquired an access permission for the electronic business card, at least some content of the electronic business card is in a state hidden from the any member. Then, a confirmation message for the permission acquiring request is returned according to a confirmation operation of the local user, such that the access permission for the electronic business card is granted to the any member, and the hidden state is no longer concealed from the any member. In other words, the local user acquiring the electronic business card and associating the electronic business card with the organization with which the local user is affiliated is equivalent to sharing the electronic business card with other members in the organization with which the local user is affiliated, such that other members may view the content of the electronic business card. However, in this embodiment, there are certain restrictions on viewing the electronic business card. That is to say, only after acquiring consent and authorization from the local user will other members in the organization with which the local user is affiliated be able to view all of the content of the electronic business card; otherwise, other members may only view basic content such as the name and the job title, and may not view at least some of other content such as contact information. As a result, the local user is in control of sharing the electronic business card.

In an embodiment, an association relationship between the local user and the electronic business card is visible to the any member. For example, when viewing the electronic business card, the any member may also see that the electronic business card is shared by the local user, so that when the any member initiates a permission acquiring request for the electronic business card, the local user may be designated as a request object. Accordingly, the local user may receive the permission acquiring request initiated by the any member for the electronic business card.

In an embodiment, the association relationship is invisible to the any member. For example, when viewing an electronic business card, the any member will not know which user shares the electronic business card. In this way, identity privacy of the sharer (such as the above-mentioned local user) may be protected, thereby preventing the any member from contacting the sharer privately, and avoiding adverse effects on the sharer. The sharer does not need to share said electronic business card with the any member out of personal relationship therewith or the superior/subordinate relationship. Accordingly, the local user may receive the permission acquiring request from the server. After the permission acquiring request is sent to the server by the any member, the server forwards the permission acquiring request to the local user according to the association relationship. In other words, since the server knows the sharer of the electronic business card, the any member only needs to indicate to the server the electronic business card for which the permission acquiring request is made, without having to know the sharer of the electronic business card. The server may then forward the permission acquiring request to the corresponding sharer (for example, the above-mentioned local user).

In an embodiment, when receiving the permission acquiring request, the local user may learn the identity information of the initiator for the permission acquiring request (for example, the above-mentioned any member), and determine, based on the identity information of the initiator, whether to grant the initiator the access permission for the related electronic business card.

In an embodiment, the local user may be provided with a unified marking function for all electronic business cards covered by the scene information. Then a unified characteristic label and/or unified annotation information set by the local user is determined, and the unified characteristic label and/or the unified annotation information is associated with all the electronic business cards covered by the scene information. When the local user acquires more electronic business cards under the same scene, in addition to associating the electronic business cards with the scene information, the local user may have the autonomy to further add a unified characteristic label and/or unified annotation information by using the provided unified marking function mentioned previously. In this case, even if there are multiple pieces of similar scene information, recognition of the related electronic business cards may be facilitated based on the unified characteristic label and/or the unified annotation information. In addition, the local user is enabled to perform a quick marking operation in batches on all the electronic business cards corresponding to the same scene information using the unified marking function.

In an embodiment, the unified characteristic label may include a predefined label provided by a client running on the electronic device, so that the predefined label may be viewed and selected by the local user. Certainly, the local user may also create a new user-defined label according to actual needs. The unified annotation information may be entered by the local user in a user-defined manner according to the actual situation.

In an embodiment, the acquired electronic business cards may be classified and displayed according to the scene information. For example, when the scene information includes time information, electronic business cards corresponding to various pieces of scene information may be sequentially displayed in reverse chronological order. For another example, when the scene information includes location information, a classification label corresponding to each location may be generated, and the local user may view, by triggering a corresponding classification label, an electronic business card acquired at a corresponding location.

In an embodiment, interaction events between the local user and a target user corresponding to the electronic business card may be recorded; and the interaction events are arranged and displayed on a display interface corresponding to the electronic business card in accordance with a time sequence of occurrences. For example, the local user may enter event content related to the target user on the electronic device, generate a corresponding interaction event, and associate the interaction event with the electronic business card. Accordingly, when viewing the electronic business card, the local user may quickly learn information such as the collaborating situation or the communication situation related to the corresponding target user by viewing the interaction events, which facilitates and enhances the communication efficiency between the two parties.

The event content may include at least one of the following: business card transferring, call records, visit records, and the like. Accordingly, the interaction events may include at least one of the following: a business card transferring event, a communication event, and a visit event, which is not limited by the present disclosure.

In an embodiment, data of the electronic business card may be updated according to business card updating data sent by the server. The business card updating data is related to a business card updating operation performed on the electronic business card by the target user. Therefore, when the target user performs the business card updating operation on the electronic business card, such as changing a phone number or a job title, the local user may acquire an updated electronic business card in a timely, accurate, and automatic manner. The target user does not need to inform the local user of the update, and the local user does not need to ask for the update. In this way, the electronic business card may be swiftly and automatically updated.

In an embodiment, a sharing link of the electronic business card may be generated, and the sharing link or sharing content representing the sharing link may be sent to a target recipient user. Herein, the sharing content representing the sharing link may include a two-dimensional barcode and the like, so that the target recipient user is enabled to acquire the sharing link by analyzing the sharing content, and further acquire the corresponding electronic business card. The sharing with the target recipient user is done using the sharing link or the sharing content. Thus, even if the target recipient user has not been in contact with the target user corresponding to the electronic business card, the target recipient user may still be able to acquire said electronic business card. For example, when the local user and the target recipient user belong to the same enterprise, the local user may quickly share the electronic business card of the target user to the target recipient user, thereby swiftly sharing the electronic business card.

In an embodiment, the electronic business card includes private content. The private content is hidden when the electronic business card of the local user is not sent to a target user corresponding to the electronic business card, and is displayed when the electronic business card of the local user is sent to the target user. For example, the target user may send the electronic business card thereof to the local user, or the local user may view the electronic business card of the target user by browsing a personal page of the target user. However, before the local user sends the electronic business card thereof to the target user, it indicates that a valid association relationship is not yet established between the local user and the target user. In this case, private content such as the phone number, the address, and the like needs to be hidden to avoid leakage. After the local user sends the electronic business card to the target user, it indicates that an association relationship is established between the local user and a peer-end user, and thus the private content may no longer be hidden, thereby ensuring smooth communication between the two parties.

In an embodiment, the local user may be provided with communication identifiers for all the electronic business cards covered by the scene information. Then, a corresponding communication group is created according to an operation of the local user triggering the communication identifiers, wherein members in the communication group include the local user and a target user corresponding to an electronic business card that is related to the scene information. By providing the communication identifiers, the present invention enables the local user to quickly create a communication group with the target users corresponding to all the electronic business cards under the same scene, which is convenient in enhancing the communication efficiency.

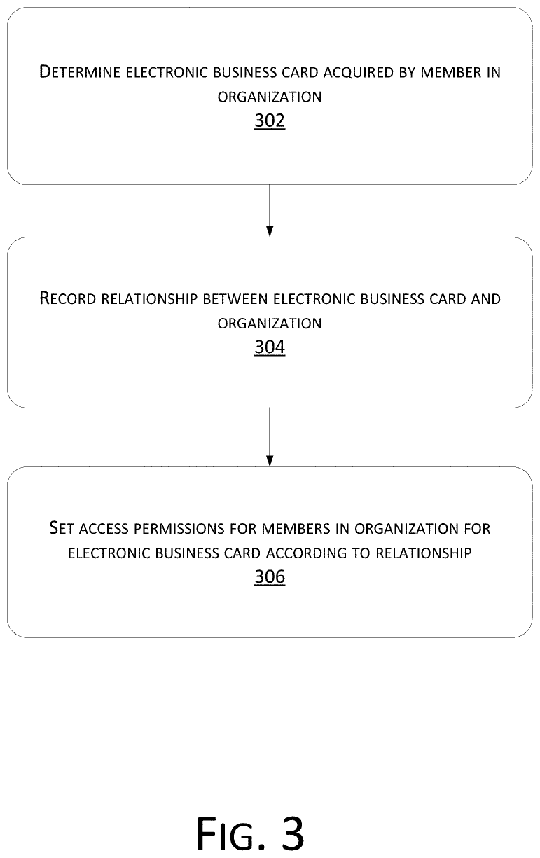

FIG. 3 is a flowchart of an electronic business card management method according to example embodiment II. As shown in FIG. 3, the method is applied to a server (such as the server 102 shown in FIG. 1), and may include the following steps:

Step 302. Determine electronic business cards acquired by members in an organization.

In an embodiment, after the members in the organization acquire the electronic business cards, the electronic business cards may be uploaded to the server and recorded by the server as being related to the organization. Here, the uploading operation may be proactively performed by the members having acquired the electronic business cards, or may be automatically performed by a client running on an electronic device used by the members after the electronic business cards are acquired.

Step 304. Record a relationship between the electronic business cards and the organization.

Step 306. Set access permissions for the members in the organization for the electronic business cards according to the relationship.

In an embodiment, the relationship between the electronic business card and the organization is recorded, so that all members belonging to the organization may acquire the access permission for the electronic business card. In this way, the electronic business card is decoupled from the member who initially acquires the electronic business card. Thus, the electronic business card may be deposited into the organization, thereby achieving the sharing of the electronic business cards among the members of the organization.

For example, when any user joins the organization, the access permission for the electronic business card may be granted to the any user. When the any user leaves the organization, the access permission of the any user for the electronic business card may be canceled.

In an embodiment, a mapping relationship between the electronic business card and an organization node corresponding to the member having acquired the electronic business card in an organizational structure of the organization may be recorded, so as to grant the member corresponding to the organization node in the organization the access permission for the electronic business card. Herein, the organization node corresponding to the member in the organizational structure represents information related to the members, such as the department, the project team, or the job title, and may certainly further represent information in more dimensions, which is not limited by the present disclosure. The mapping relationship between the electronic business card and the organization node is recorded. Thus, after the electronic business card is acquired by a member, the electronic business card is not only retained by the member, but it may also be further deposited into the organizational structure of the organization, thereby enabling the electronic business card to be decoupled from the specific member.

In an embodiment, an acquiring permission is granted to the member corresponding to the organization node in the organization. Through this design, even if the member corresponding to the organization node is changed, a different member after the change can still directly acquire the electronic business card that is viewable by the previous member. In this way, a handover process between members is simplified, and any losses resulted from the member not proactively handing over the electronic business card after leaving the organization may then be avoided, thereby ensuring that the different member after the change can smoothly carry out related work.

In an embodiment, when a member corresponding to the organization node in the organization is changed, an electronic business card of the different member after the change may be pushed to a target user corresponding to the electronic business card. It can be seen that the mapping relationship between the electronic business card and the organization node is recorded, so that when the member corresponding to the organization node is changed, the target user corresponding to the electronic business card may quickly learn about a related change situation so as to respond to or deal with the change in a timely manner, thereby ensuring that the two parties always maintain a professional and efficient collaborating relationship.

In an embodiment, an association node related to the organization node in the organizational structure of the organization may be determined, and the acquiring permission for the electronic business card is granted to a member corresponding to the association node in the organization. For example, the organization node and the association node may be within the same department. After a member corresponding to the organization node acquires an electronic business card, a member corresponding to the association node may be granted an acquiring permission for the electronic business card, which facilitates the communication and interaction between the member corresponding to the association node and a target user corresponding to the electronic business card. In other words, communication and interaction between the member corresponding to the organization node and the target user may be extended to communication and interaction between members in the entire department and the target user.

In an embodiment, corresponding scene information when the electronic business cards are acquired may be recorded. The scene information is used to classify and display the electronic business cards. For example, when the scene information includes time information, electronic business cards corresponding to various pieces of scene information may be sequentially displayed in reverse chronological order. For another example, when the scene information includes location information, a classification label corresponding to each location may be generated, and the local user may view, by triggering a corresponding classification label, an electronic business card acquired at a corresponding location. The electronic business card is associated with the corresponding scene information and said association is stored. Thus, even if a user cannot remember where or when an electronic business card is acquired after a long period of time, when viewing the electronic business card, the user may recall memories related thereto according to the associated scene information. Or the user may quickly locate the corresponding electronic business card according to the scene information, thereby assisting the user in efficiently finalizing relevant events.

In an embodiment, the scene information may include at least one of the following: a time, a location, a pre-planned event related to the time, a pre-planned event related to the location, a pre-planned event related to the time and the location, and the like, which is not limited by the present disclosure.

The pre-planned event may include any event preset or pre-planned by the local user, such as schedule planning or an item to be reminded, which is not limited by the present disclosure. For example, when the schedule planning includes “planning related to contacting staff of the enterprise AA on project X at 2 p.m. on September 18”, if an electronic business card is acquired near 2 p.m. (for example, within half an hour before or after 2 p.m.) on September 18, it may be considered that the electronic business card is likely to be related to the above-mentioned schedule planning; and said schedule planning may be acquired as the scene information corresponding to the electronic business card. For another example, when the item to be reminded includes “discussing project Y in hotel XX”, if GPS positioning information of the electronic device shows that the electronic device is at the hotel XX when the electronic business card is acquired, it may be considered that the electronic business card is likely to be related to the above-mentioned item to be reminded. Then said item to be reminded may be acquired as the scene information corresponding to the electronic business card.

In an embodiment, data of the electronic business card may be updated according to a business card updating operation performed on the electronic business card by a target user. Therefore, when the target user performs the business card updating operation on the electronic business card, such as changing a phone number or a job title, a member in the organization may acquire an updated electronic business card in a timely, accurate, and automatic manner. The target user does not need to inform the local user of the update, and the member in the organization does not need to ask for the update. In this way, the electronic business card can be swiftly and automatically updated.

In an embodiment, when any member in the organization has not acquired the access permission for the electronic business card, at least some content of the electronic business card is in a state hidden from the any member. When receiving a permission acquiring request initiated by the any member for the electronic business card, a server may forward the permission acquiring request to the member having acquired the electronic business card. The access permission for the electronic business card is then granted to the any member according to a confirmation message returned by the member having acquired the electronic business card. In other words, a member (i.e., the member having acquired the electronic business card) acquiring the electronic business card and associating the electronic business card with the organization to which the member belongs is equivalent to sharing the electronic business card with other members (such as the above-mentioned any member) in the organization to which said member belongs, such that other members may view the content of the electronic business card. However, in this embodiment, there are certain restrictions on viewing the electronic business card. That is to say, only after acquiring consent and authorization from the any member will other members in the organization with which the any member is affiliated be able to view all of the content of the electronic business card; otherwise, other members may only view basic content such as the name and the job title, and may not view at least some of other content such as contact information. As a result, the any member is in control of sharing the electronic business card.

In an embodiment, an association relationship between the electronic business card and a member having acquired the electronic business card is visible to the any member; and a request object of the permission acquiring request is designated by the any member as the member having acquired the electronic business card. For example, when viewing the electronic business card, the any member may also view that the electronic business card is shared by a certain member. Thus, when the any member initiates a permission acquiring request for the electronic business card, the certain member may be designated as the request object. Accordingly, the certain member may receive the permission acquiring request initiated by the any member for the electronic business card to the certain member.

In an embodiment, the association relationship is invisible to the any member. For example, when viewing an electronic business card, the any member will not know which user shares the electronic business card. In this way, identity privacy of the sharer (i.e., the above-mentioned member having acquired the electronic business card, such as said certain member) may be protected, thereby preventing the any member from contacting the sharer privately, and avoiding adverse effects on the sharer. The sharer does not need to share said electronic business card with the any member out of personal relationship therewith or the superior/subordinate relationship. Accordingly, when the permission acquiring request initiated by the any member for the electronic business card is received, the server may forward, according to the association relationship, the permission acquiring request to the member having acquired the electronic business card. In other words, since the server knows the sharer of the electronic business card, the any member only needs to indicate to the server the electronic business card for which the permission acquiring request is made, without having to know the sharer of the electronic business card. The server may then forward the permission acquiring request to the corresponding sharer.

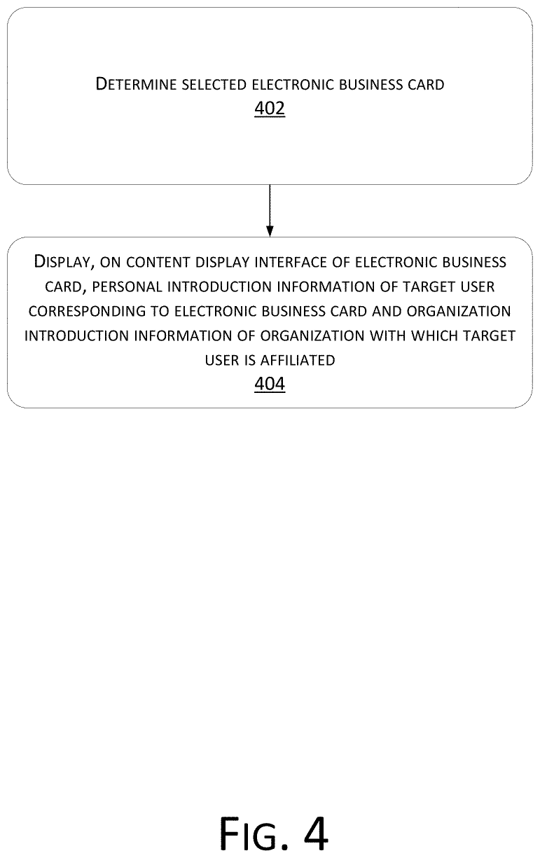

FIG. 4 is a flowchart of an electronic business card management method according to example embodiment III. As shown in FIG. 4, the method is applied to an electronic device (such as the mobile phones 106 to 110 shown in FIG. 1), and may include the following steps:

Step 402. Determine a selected electronic business card.

In an embodiment, the electronic business card may be acquired in any manner, which is not limited by the present disclosure.

For example, the electronic device may receive an electronic business card proactively sent by an adjacent electronic device. In other words, the operation of sending the electronic business card may be triggered and implemented unilaterally. For another example, the electronic device may proactively send an electronic business card of a local user to the adjacent electronic device, and receive an electronic business card returned by the adjacent electronic device. In other words, electronic business cards are to be sent to each other based on an exchange principle.

Here, sending electronic business cards between the electronic device and the adjacent electronic device may be implemented in various manners. For example, the electronic device may establish a near field communication connection with the adjacent electronic device based on Bluetooth, Wi-Fi, or the like, or the electronic device may establish a remote communication connection with the adjacent electronic device (for example, based on a mobile communication technology such as 4G or 5G). In this way, the electronic device may acquire an electronic business card through the near field communication connection or the remote communication connection. In the technical solution based on the remote communication connection, the electronic device may proactively request for an electronic business card from the adjacent electronic device, or the adjacent electronic device may proactively send an electronic business card to the electronic device, or a server may proactively push an electronic business card of the adjacent electronic device to the electronic device when determining that the electronic device is geographically close to the adjacent electronic device (for example, the determination may be performed based on GPS positioning data, based on a connected Wi-Fi hotspot when the location of the Wi-Fi hotspot is known, or based on a nearby Bluetooth beacon when the location of the Bluetooth beacon is known).

For another example, an electronic business card of a user having logged onto the adjacent electronic device may be acquired from the adjacent electronic device or the server based on a verification code related to the adjacent electronic device. For example, after the adjacent electronic device generates a verification code related to sharing the electronic business card, the local user may enter the verification code on the electronic device, or the electronic device may directly scan the verification code. Then the electronic device may send a verification request including the verification code to the adjacent electronic device or the server. After the adjacent electronic device or the server performs verification and the verification is successful, the electronic business card of the user having logged onto the adjacent electronic device is acquired. In this way, randomly sending electronic business cards may then be confined.

In an embodiment, the electronic device may create a corresponding electronic business card based on a result of scanning information on a paper business card. For example, the electronic device may scan the paper business card (i.e., a traditional business card, the material of which may also be plastic or any other material, which is not limited to paper) by using a camera, so as to recognize content of the business card based on an optical character recognition (OCR) technology and the like, and organize the recognition result in a preset format, and create an electronic business card for the local user.

Step 404. Display, on a content display interface of the electronic business card, personal introduction information of a target user corresponding to the electronic business card and organization introduction information of an organization with which the target user is affiliated.

In an embodiment, since virtual information presented on the electronic business card is not restricted by dimensions of a traditional paper business card, more introduction information may be added to the electronic business card. For example, in addition to the personal introduction information of the target user, the organization introduction information of the organization with which the target user is affiliated may be further included.

In an embodiment, the personal introduction information and the organization introduction information are added to the electronic business card. Thus, even if the personal introduction information is not comprehensive enough, the local user can still quickly recall or think of information or events related to the target user according to the organization introduction information. Examples of said information or events are communications and interactions that have taken place between the two parties.

In an embodiment, when the local user is not aware of the organization with which the target user is affiliated, by adding the organization introduction information to the electronic business card, the local user is enabled to quickly learn about the organization based on the organization introduction information. In particular, for an organization with which the local user has not come into contact before, the local user may quickly learn about the organization based on the organization introduction information without having to perform an additional search operation.

In an embodiment, switching to an organization homepage interface corresponding to the organization with which the target user is affiliated may be performed according to an operation of triggering the organization introduction information. For example, the organization introduction information may include brief introduction information of the organization with which the target user is affiliated; and the organization homepage interface may include detailed introduction information of the organization with which the target user is affiliated. Thus, when the local user is interested to learn more about the target user or the organization with which the target user is affiliated, the local user may learn further detailed information about the organization with which the target user is affiliated.

In an embodiment, corresponding scene information when the electronic business card is acquired may be displayed on the content display interface of the electronic business card. Thus, even if a user cannot remember where or when an electronic business card is acquired after a long period of time, when viewing the electronic business card, the user may recall memories related thereto according to the associated scene information. Or the user may quickly locate the corresponding electronic business card according to the scene information, thereby assisting the user in efficiently finalizing relevant events.

In an embodiment, the scene information may include at least one of the following: a time, a location, a pre-planned event related to the time, a pre-planned event related to the location, a pre-planned event related to the time and the location, and the like, which is not limited by the present disclosure.

The pre-planned event may include any event preset or pre-planned by the local user, such as schedule planning or an item to be reminded, which is not limited by the present disclosure. For example, when the schedule planning includes “planning related to contacting staff of the enterprise AA on project X at 2 p.m. on September 18”, if an electronic business card is acquired near 2 p.m. (for example, within half an hour before or after 2 p.m.) on September 18, it may be considered that the electronic business card is likely to be related to the above-mentioned schedule planning; and said schedule planning may be acquired as the scene information corresponding to the electronic business card. For another example, when the item to be reminded includes “discussing project Y in hotel XX”, if GPS positioning information of the electronic device shows that the electronic device is at the hotel XX when the electronic business card is acquired, it may be considered that the electronic business card is likely to be related to the above-mentioned item to be reminded. Then said item to be reminded may be acquired as the scene information corresponding to the electronic business card.

In an embodiment, a characteristic label and/or annotation information marked by the local user for the electronic business card may be displayed on the content display interface of the electronic business card. Thus, the local user may quickly think of information or events related to the target user corresponding to the electronic business card, thereby avoiding the situation where the user cannot remember where or when an electronic business card is acquired after a long period of time, thereby assisting the user in efficiently finalizing events related to the target user.

In an embodiment, after the electronic business card is acquired by a specific member in the organization with which the local user is affiliated, the electronic business card is associated with the organization with which the local user is affiliated. When the local user has not acquired the access permission, some content of the personal introduction information may be displayed to the local user, so that private content in the personal introduction information is in a hidden state. However, the local user may initiate a permission acquiring request for the electronic business card to a server (the local user may not be able to learn the sharer of the electronic business card; and in this case, a request object of the permission acquiring request has not been designated), such that the server forwards the permission acquiring request to the specific member according to an association relationship between the specific member and the electronic business card. The specific member determines whether to grant the local user the access permission for the electronic business card. Accordingly, when the local user has the access permission, all of the content of the personal introduction information may be displayed to the local user. In other words, the specific member having acquired the electronic business card and associating the electronic business card with the organization with which the local user is affiliated is equivalent to sharing the electronic business card with other members (such as the local user) in the organization with which the local user is affiliated, such that the local user may view the content of the electronic business card. However, in this embodiment, there are certain restrictions on viewing the electronic business card. That is to say, only after acquiring consent and authorization from the specific member will the local user be able to view all of the content of the electronic business card; otherwise, other members may only view basic content such as the name and the job title, and may not view at least some of other content such as contact information. As a result, as the sharer, the specific member is in control of sharing the electronic business card.

In an embodiment, the association relationship between the specific member and the electronic business card is visible to the local user. For example, when viewing the electronic business card, the local user may also view that the electronic business card is shared by the specific member. Thus, when initiating a permission acquiring request for the electronic business card, the local user may designate the specific member as the request object. In this way, the permission acquiring request for the electronic business card is directly initiated to the specific member. The server does not need to query the association relationship between the specific member and the electronic business card nor does the server need to perform a forwarding operation based on the association relationship.

For ease of understanding, an enterprise instant messaging application T is used as an example to illustrate the technical solutions of one or more embodiments of the present disclosure. Assuming that a client of the application T runs on the mobile phone 106, and a server end of the application T runs on the server 102; a user logs into the client of the application T on the mobile phone 106 with a registered account. For example, a member “user A” from the enterprise AA logs into the mobile phone 106 with a registered account.

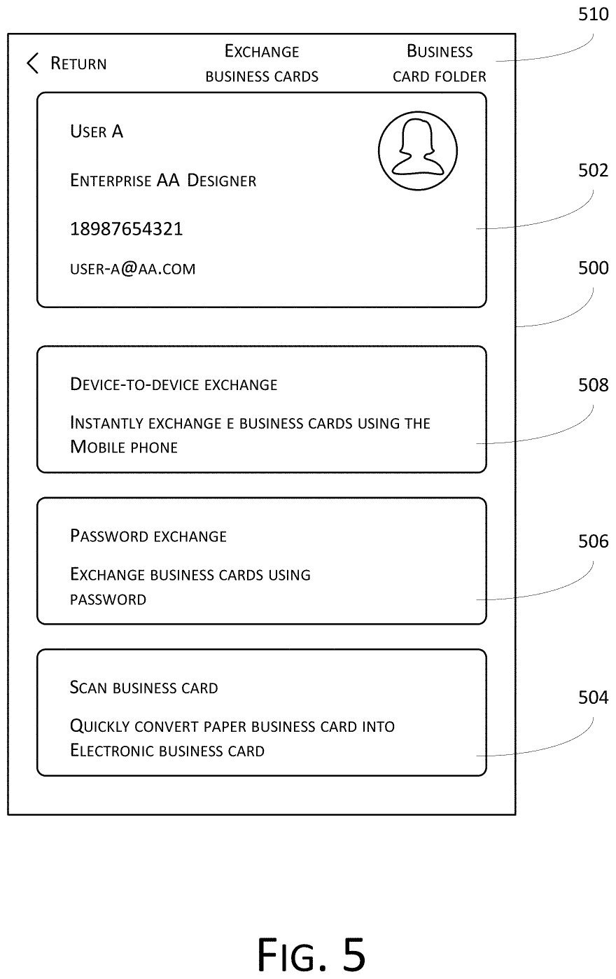

Based on the client of the application T running on the mobile phone 106, the user A may trigger a business card exchange function. For example, FIG. 5 is a schematic diagram of a function trigger interface according to an example embodiment. The user A may trigger the business card exchange function by using the function trigger interface 500 shown in FIG. 5, so as to exchange electronic business cards with another user.

In an embodiment, the function trigger interface 500 may include electronic business card information 502 of the user A, which may include some or all of the information in the electronic business card of the user A. For example, the electronic business card information 502 shown in FIG. 5 may include a name, an enterprise with which the user A is affiliated, a job title, a profile photo, a mobile phone number, an e-mail address, and the like.

In an embodiment, the function trigger interface 500 provides various alternative exchange manners for the user A to choose.

For example, the user A may use the exchange manner of “scanning a business card” corresponding to an option 504 on the function trigger interface 500. For example, after the option 504 is triggered, the mobile phone 106 may start a camera to view or take photos of paper business cards of users B to D, collect and recognize business card information printed on the paper business cards, and then create electronic business cards of the users B to D according to recognition results.

For another example, the user A may use the exchange manner of “password exchange” corresponding to an option 506 on the function trigger interface 500. For example, after the option 506 is triggered, the mobile phone 106 may display an exchange password, and the users B to D may view the exchange password and manually enter the exchange password into their respective electronic devices (or scan and recognize the exchange password by using their respective electronic devices). Taking the electronic device used by the user B for example. The electronic device may send a business card exchange request to the mobile phone 106, and the mobile phone 106 may exchange an electronic business card with the electronic device after determining that the business card exchange request includes the above-mentioned exchange password. In other words, the mobile phone 106 sends the electronic business card of the user A and receives the electronic business card of the user B. Still taking the electronic device used by the user B for example. The electronic device may send a business card exchange request to the server 102, and the server 102 learns about the above-mentioned exchange password in advance (the mobile phone 106 generates the exchange password and then uploads the exchange password to the server 102; or the exchange password is generated by the server 102); the server 102 may then verify whether the business card exchange request includes the above-mentioned exchange password, and notify the mobile phone 106 of a verification result, such that the mobile phone 106 may determine whether to exchange the electronic business card with the electronic device. Scenarios of the users C to D are similar to those of the user B, and are not elaborated herein.

For another example, the user A may use the exchange manner of “device-to-device exchange” corresponding to an option 508 on the function trigger interface 500. Assuming that the user A, the user B, the user C, and the user D would like to exchange electronic business cards, the user A may trigger the option 508 on the mobile phone 106, and the user B, the user C, and the user D may also trigger the corresponding option on their respective electronic devices, so that the “device-to-device business card exchange” function is activated on all the electronic devices respectively used by the users A to D. In this way, the electronic devices are enabled to locate one another by searching for nearby electronic devices on which the “device-to-device business card exchange” function is activated using the Bluetooth module. For example, the mobile phone 106 may find the respective electronic devices used by the users B to D.

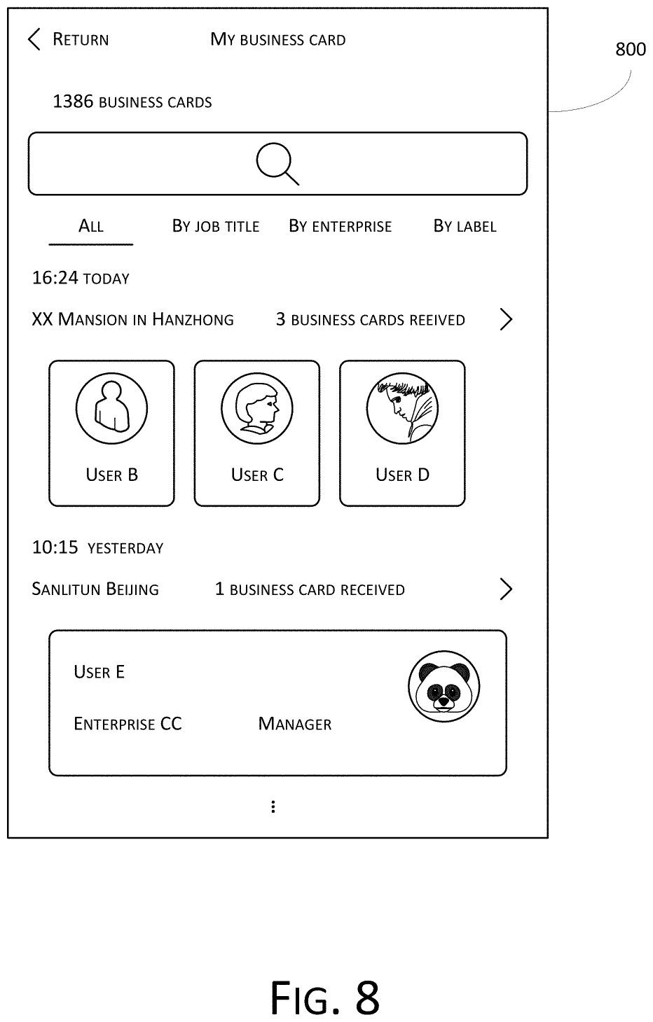

Through an entry such as an option 510 shown in FIG. 5, the user A may switch to a business card folder interface 800 shown in FIG. 8 to view and manage acquired electronic business cards.

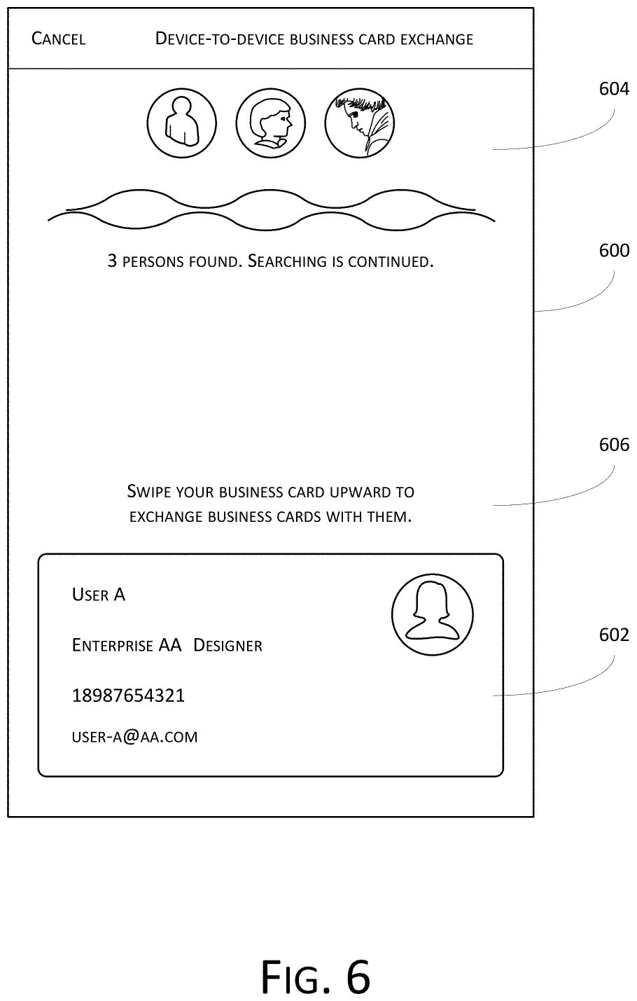

FIG. 6 is a schematic diagram of an interaction interface for device-to-device business cards exchanging according to an example embodiment. As shown in FIG. 6, an interaction interface 600 may display electronic business card information 602 (equivalent to the above-mentioned electronic business card information 502) of a user A, and may further display a search result 604 based on a Bluetooth module. For example, the search result 604 includes information such as profile photos of the found users B to D and a text prompt of “3 persons found, searching continued” may be provided. Herein, the interaction interface 600 may display interaction prompt information 606. For example, a text “Swipe your business card upward to exchange business cards with them” in FIG. 6 instructs the user A to touch and swipe upward on the electronic business card information 602. An electronic device 13 may cooperatively display on the interaction interface 600 a location, a size, a moving speed, and the like of the electronic business card information 602, thereby showing an effect of the user A “dragging” or “handing out” the electronic business card information 602 to the found users B to D. The user A is then enabled to send the electronic business card thereof to the users B to D respectively, and receive the respective electronic business cards of the users B to D, thereby finally completing an exchange of the electronic business cards.

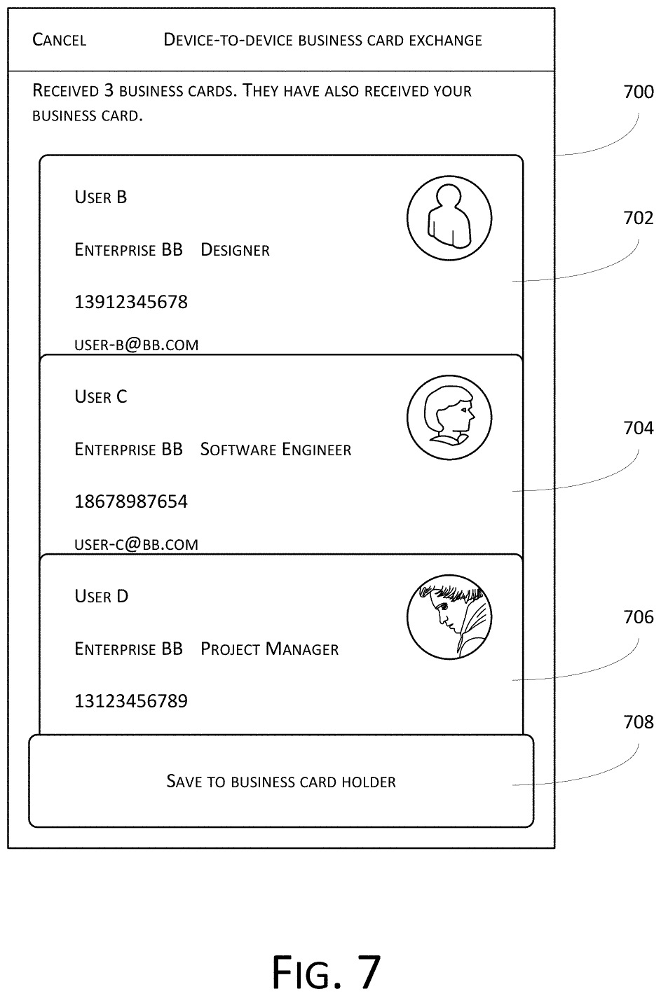

FIG. 7 is a schematic diagram of an interface for displaying a result of device-to-device business cards exchanging according to an example embodiment. Based on the above-mentioned “device-to-device business card exchange” function, the mobile phone 106 may exchange electronic business cards with other electronic devices, and display the exchange result on a result display interface 700 shown in FIG. 7. As shown in FIG. 7, assuming that the mobile phone 106 acquires the electronic business cards of the users B to D through an exchange, the result display interface 700 may display electronic business card information 702 corresponding to the user B, electronic business card information 704 corresponding to the user C, and electronic business card information 706 corresponding to the user D, such that the user A may determine whether to acquire all the electronic business cards that the user A hopes to acquire through the exchange, and whether unwanted electronic business card are included (for example, an irrelevant person happens to be using the “device-to-device business card exchange” function nearby). If it is found that an electronic business card of a user is not received, the acquiring process may be started by using the above-mentioned function trigger interface 500 again. If it is hoped to delete a received electronic business card, corresponding electronic business card information on the result display interface 700 may be triggered to quickly delete the electronic business card information and the electronic business card corresponding thereto. Taking the electronic business card information 702 corresponding to the user B for example. The user A may touch the electronic business card information 702 and swipe to the left to quickly delete the electronic business card information 702 (or after the user A swipes to the left, a deletion prompt is provided, and deletion is performed after the user A reconfirms) and the electronic business card of the user B. Assuming that all of the electronic business card information 702 to 706 on the result display interface 700 need to be kept, the user A may save the electronic business cards of the users B to D to a business card folder by triggering an option 708. The business card folder stores all the electronic business cards acquired by the user A.

Certainly, the mobile phone 106 may skip the result display interface 700 shown in FIG. 7 and directly save the received electronic business cards to the business card folder. The user A may browse the business card folder to determine whether a desired electronic business card has been received, and delete unwanted electronic business cards.

FIG. 8 is a schematic diagram of a business card folder interface according to an example embodiment. Through an entry such as an option 510 shown in FIG. 5, the user A may switch to a business card folder interface 800 shown in FIG. 8 to view and manage acquired electronic business cards.

In an embodiment, the business card folder interface 800 may include several label pages, such as “All”, “By job title”, “By enterprise”, and “By label” shown in FIG. 8. The electronic business cards acquired by the user A may be sorted or classified and displayed based on different dimensions. Certainly, sorting or classification and display may be further implemented based on other dimensions, which is not limited by the present disclosure.

Taking the “All” label page for example. The client of the application T running on the mobile phone 106 may acquire received time and received locations of electronic business cards, then classify the electronic business cards acquired by the user A into several groups, and sequentially sort and display each group of electronic business cards according to the received time corresponding to each group in reverse chronological order. For each group of electronic business cards, other information such as corresponding received locations and the quantity of electronic business cards may be further displayed. For example, as shown in FIG. 8, the received time for a group of electronic business cards recently received is “16:24 today” with the receiving location being “XX Mansion in Hangzhou” and the quantity of business cards being “3”. In addition, thumbnail information of the group of electronic business cards may also be displayed, such that the user A may have a direct and general idea about these three electronic business cards. For example, FIG. 8 further shows information such as users' names and the respective user profile photos of these three electronic business cards, from which it can be learned that these three electronic business cards belong to the user B, the user C, and the user D in the above-mentioned embodiment. With regard to the next group of electronic business cards with the received time being “10:15 yesterday” and the received location being “Sanlitun Beijing”, since there is only “1” electronic business card, more information of the electronic business card may be displayed, such as the user name, the user profile photo, the enterprise with which the user is affiliated, and the job title shown in FIG. 8, as the display section occupies roughly the same size of area as that of the above-mentioned three business cards. Based on the display of the above-mentioned content such as the received time, the received location, and the business card information, when viewing a related electronic business card, the user A may recall information or events related to the electronic business card from these various dimensions, thereby assisting the user A in establishing an association between the electronic business card and the user thereof in reality.

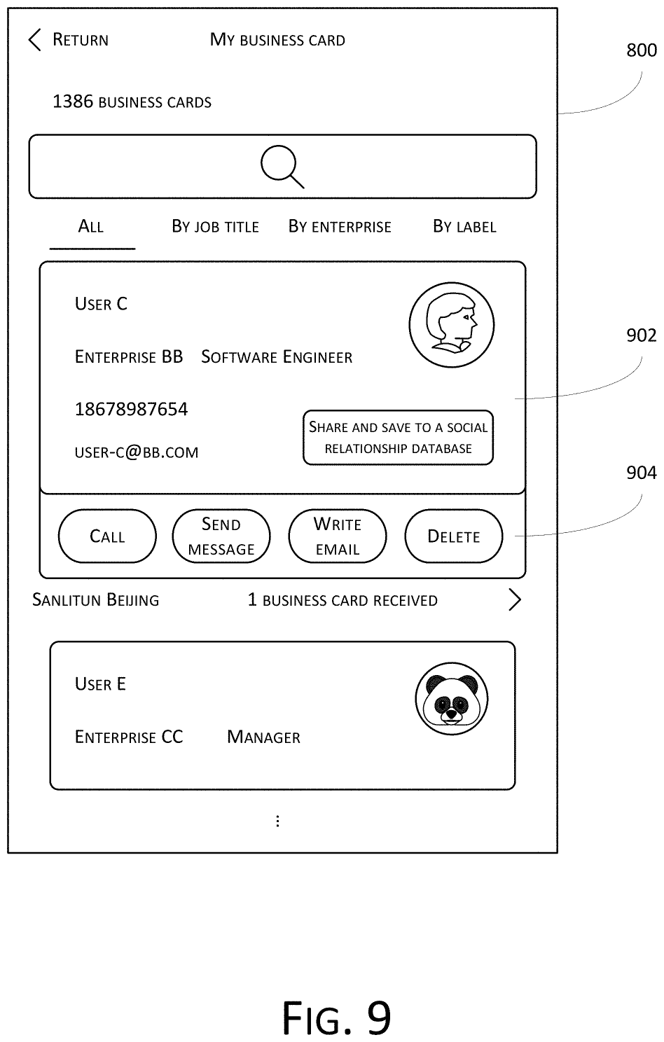

FIG. 9 is a schematic diagram of performing an operation on an electronic business card according to an example embodiment. The user A may trigger an electronic business card of interest on the business card folder interface 800 to perform related operations. For example, as shown in FIG. 9, when it is detected that the electronic business card of the user C is triggered, electronic business card information 902 corresponding to the user C may be displayed. On the one hand, the electronic business card information 902 includes personal introduction information of the user C with more content included than those included in the business card information shown in FIG. 8, thus helping the user A to easily view and understand the content. On the other hand, an operation menu 904 for the user C or the electronic business card thereof may be displayed. The operation menu 904 includes several optional operations, for example, operations such as “call”, “send a message”, or “write an e-mail” are to be performed for the user C, or operations such as “delete” or “follow” are to be performed on the electronic business card.

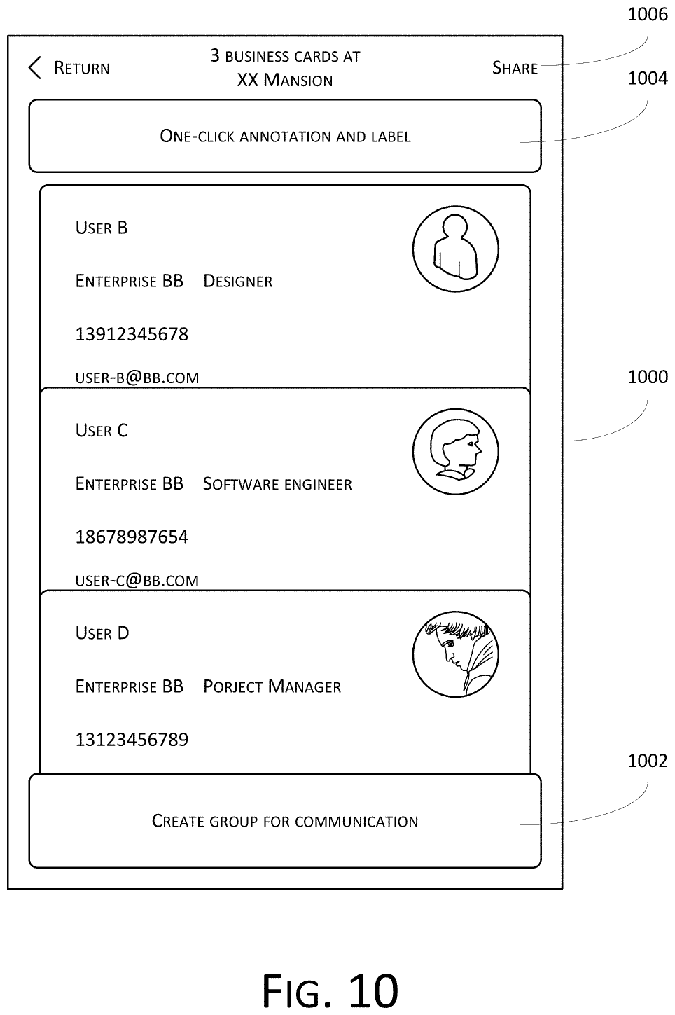

FIG. 10 is a schematic diagram of a batch operation interface according to an example embodiment. The user A may select a group of electronic business cards shown on the business card folder interface 800, and then perform batch operations on the group of electronic business cards by using a batch operation interface 1000 shown in FIG. 10. Assuming that the user A selects, from the business card folder interface 800, a group of electronic business cards with received time being “16:24 today”, received location being “XX Mansion in Hangzhou”, and the business card quantity being “3”, the mobile phone 106 may display at least some information of the three corresponding electronic business cards on the batch operation interface 1000, so that the user A can learn more about the objects to which the operations will be performed.

In an embodiment, the batch operation interface 1000 may include a quick group creation option 1002. When a triggering operation performed by the user A on the quick group creation option 1002 is detected, a corresponding communication group may be instantly created. Members in the communication group include the user A and the target users corresponding to the three electronic business cards on the batch operation interface 1000, namely, the foregoing users B to D. In this case, the user A does not need to manually select group members one by one.

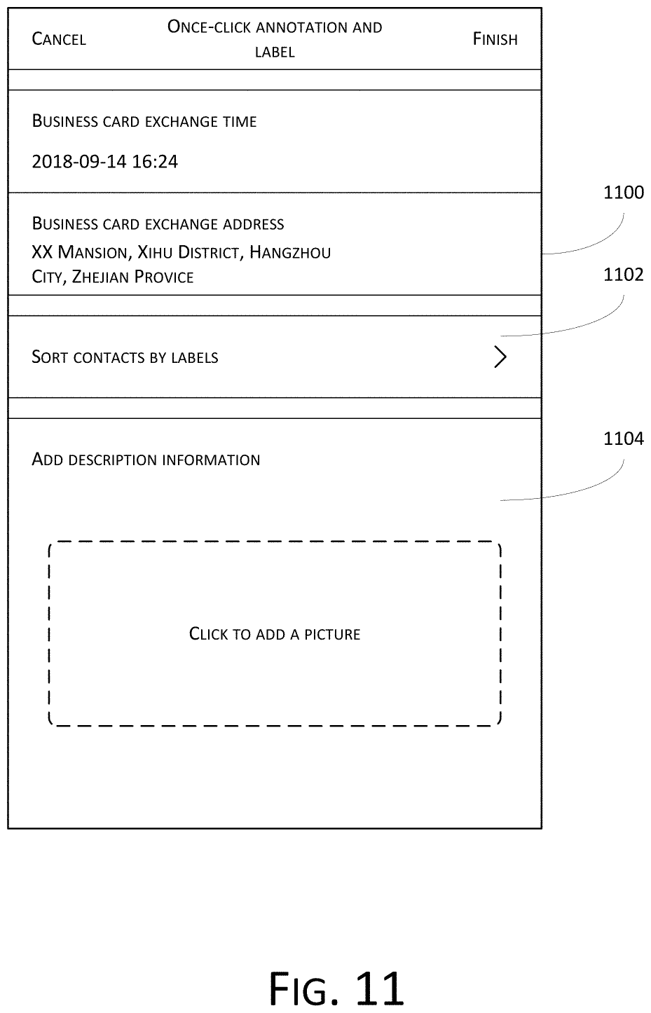

In an embodiment, the batch operation interface 1000 may include a one-click annotation and label option 1004, which can help the user A to quickly add unified annotation information and/or labels to the three electronic business cards shown on the batch operation interface 1000, so as to instantly make a note of a common characteristic for the target users corresponding to these electronic business cards. For example, FIG. 11 is a schematic diagram of an annotation and label editing interface according to an example embodiment. As shown in FIG. 11, the annotation and label editing interface 1100 may include a label setting option 1102 and an annotation setting option 1104. The label setting option 1102 is used to set unified labels for the above-mentioned three electronic business cards in batches, and the annotation setting option 1104 is used to set unified annotations for the above-mentioned three electronic business cards in batches. The user A does not need to separately set a label or an annotation for each electronic business card.

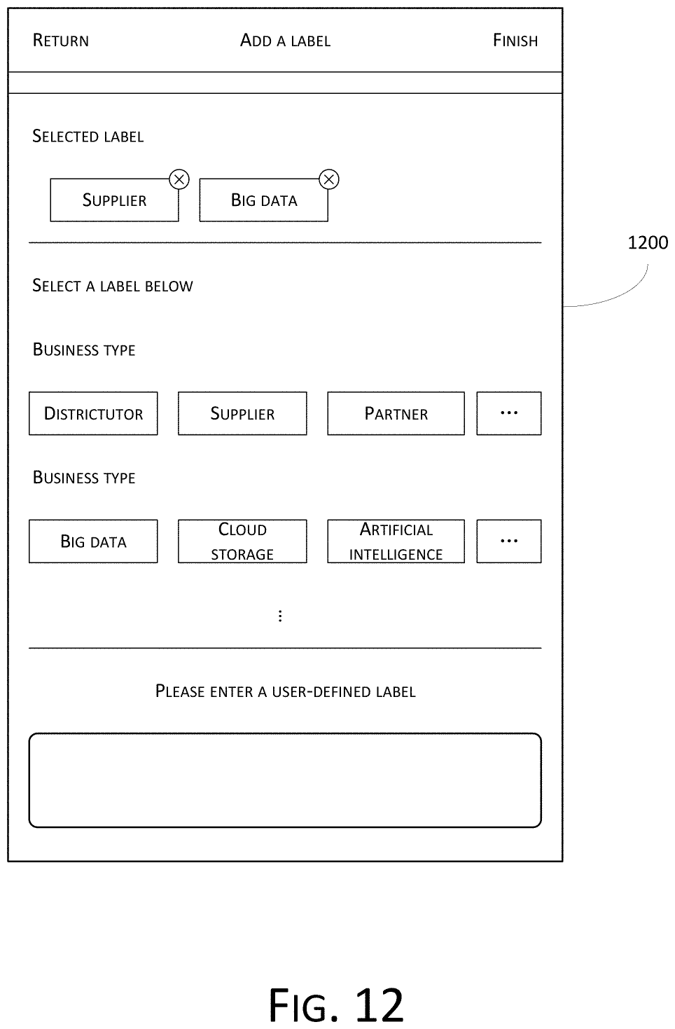

FIG. 12 is a schematic diagram of a label setting interface according to an example embodiment. In response to an operation of triggering the label setting option 1102 by the user A, the interface is switched to a label setting interface 1200 shown in FIG. 12. The label setting interface 1200 may provide label candidates preset by the application T, and these labels may be classified and displayed according to different dimensions such as relationship types and service types, thus helping the user A to easily view and select the content. Certainly, the user A may also create and add a user-defined label, and does not necessarily use the above-mentioned label candidates. The label setting interface 1200 may show a label selected by the user A. For example, selected labels shown in FIG. 12 include “Supplier”, “Big data”, and the like.

In an embodiment, the user A may enter more types of annotation information such as a text, a picture, an audio, and a video by using the above-mentioned annotation setting option 1104, which is not limited by the present disclosure. For example, after exchanging business cards with the users B to D using the device-to-device function, the user A may take a group photo of the user B, the user C, and the user D on the spot, and add the group photo as annotation information of the three corresponding electronic business cards using the annotation setting option 1104. In this way, an association relationship between an electronic business card and a real user may be more directly indicated in the subsequent process.

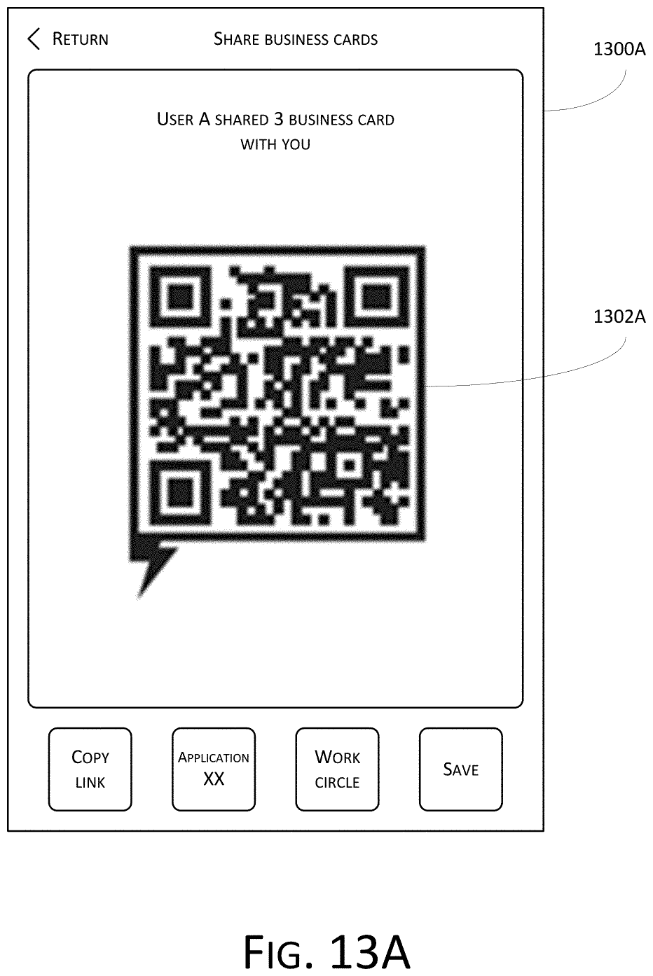

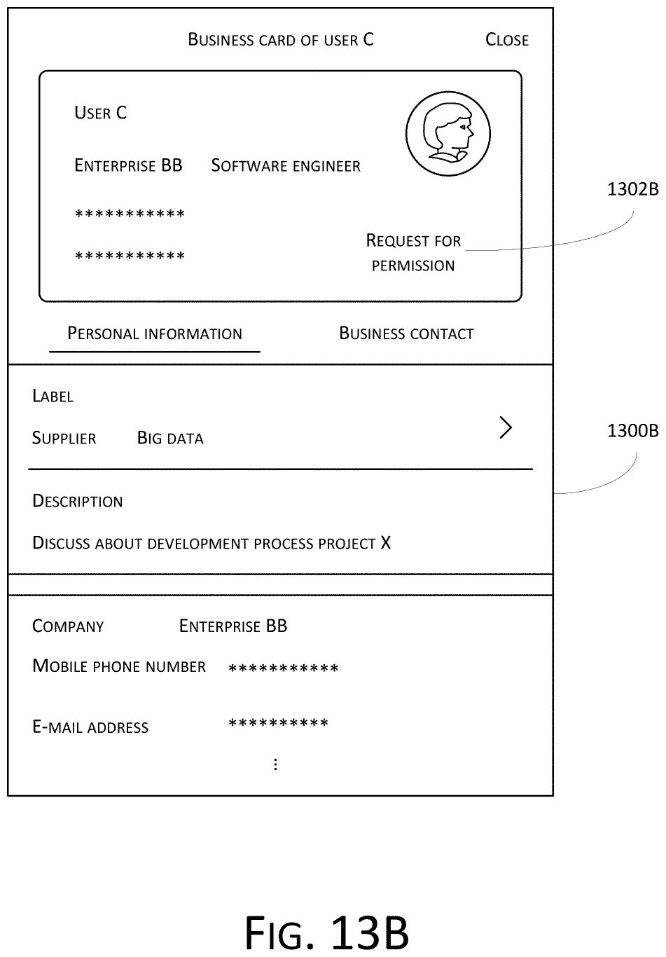

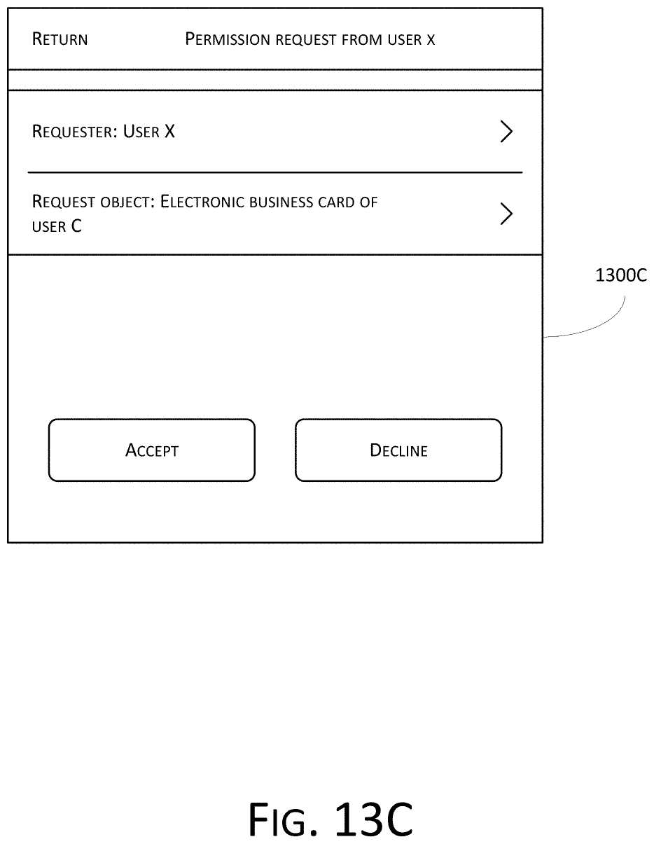

In an embodiment, the batch operation interface 1000 may include a sharing option 1006, which may be used to share, in batches, the three electronic business cards displayed on the batch operation interface 1000. For example, FIG. 13A is a schematic diagram of a business card sharing interface according to an example embodiment. In response to an operation of triggering the sharing option 1006 by the user A, the interface is switched to a business card sharing interface 1300A shown in FIG. 13A. The business card sharing interface 1300A may include a two-dimensional barcode 1302A, and the two-dimensional barcode 1302A includes sharing links corresponding to the above-mentioned three electronic business cards of the users B to D, such that the user A may accordingly perform an operation to share said electronic business cards with another user.

The user A may directly display the two-dimensional barcode 1302A on the mobile phone 106 to another user. The another user may recognize the two-dimensional barcode 1302A by using an electronic device thereof, access the corresponding sharing links, and acquire the three electronic business cards of the above-mentioned users B to D. Alternatively, the user A may copy the above-mentioned sharing links by triggering a “Copy the link” option on the business card sharing interface 1300A, so as to paste the sharing links and send them to another user, so that the another user may directly access the sharing links. Alternatively, the user A may trigger an “Application XX” option on the business card sharing interface 1300A to send the two-dimensional barcode 1302A to another user in the “application XX” other than the “application T”, to achieve cross-application sharing of electronic business cards. Alternatively, the user A may trigger a “Work circle” option on the business card sharing interface 1300A to send the two-dimensional barcode 1302A to a social networking platform named “Work circle”. The social networking platform may belong to the “application T” or another application such as the above-mentioned “application XX”. Alternatively, the user A may trigger a “Save” option on the business card sharing interface 1300A to store the two-dimensional barcode 1302A in a local photo album of the mobile phone 106 in a form of a picture, and may subsequently share the picture including the two-dimensional barcode 1302A saved in the local photo album.

In an embodiment, in addition to the user A proactively sharing acquired electronic business cards by using the above-mentioned sharing option 1006, a server end of the application T running on the server 102 may further proactively deposit electronic business cards acquired by members into the enterprise AA. For example, after the user A acquires the electronic business cards of the users B to D, the mobile phone 106 may upload these electronic business cards to the server 102. According to the organization nodes corresponding to the user A in an organizational structure of the enterprise AA, the server 102 may map the electronic business cards to the organization nodes (which correspond to a department to which the user A belongs, a job title thereof, and the like) corresponding to the user A, instead of mapping these electronic business cards to the user A. Thus, these electronic business cards are deposited into the organizational structure of the enterprise AA. Then, when the user A later leaves the organization or changes to a different position and assuming that a user E replaces the user A, then the user A does not need to pass the acquired electronic business cards to the user E. Instead, the user E is associated to the organization nodes originally corresponding to the user A. The server 102 may then automatically grant a related permission to the user E, such that the user E may take over the electronic business cards originally acquired by the user A. If the user A leaves the organization, the server 102 may further withdraw the permissions of the user A for related electronic business cards to avoid information leakage. In addition, when an enterprise member corresponding to an organization node is changed, the server 102 may further send, based on a mapping relationship between an electronic business card and the organization node, a prompt to a target user corresponding to the electronic business card by, for example, notifying the users B to D that the user A has left the organization and that the user E has filled the position. The server 102 may then push the electronic business card of the user E to the users B to D.

The server 102 may further manage electronic business cards based on the permission levels. Each user in the enterprise AA has a corresponding permission level, and the permission level is related to the department to which the user belongs, whether the held position is a high or low ranked one, and the like. For example, when the permission level of the user A is level 3, in addition to directly acquire an electronic business card, the user A may further acquire electronic business cards acquired by another user whose permission level is lower than level 3. For example, when the permission level of a user F is level 2, the user A has a permission to view electronic business cards acquired by the user F, or the server 102 may proactively push the electronic business cards acquired by the user F to the user A. Certainly, the user A may choose whether to add or not to add the electronic business cards to his own business card folder.

In an embodiment where the user B is used as an example, and assuming that the electronic business card of the user B is updated, since the user A has already acquired said electronic business card, the server 102 may proactively push the updated data to the user A, so as to update content of the electronic business card of the user B acquired by the user A. In addition, the user A may be prompted about the update, such that the user A may learn about the updated content of the electronic business card of the user B.

In an embodiment, a social relationship database associated with the enterprise AA may be established. Electronic business cards acquired by members in the enterprise AA are deposited into the social relationship database, such that the social relationship database may be shared among the members in the enterprise AA. Different from the automatic deposition of electronic business cards in the above-mentioned embodiment, enterprise members may choose whether to share electronic business cards according to actual needs. For example, as shown in FIG. 9, the electronic business card of the user C is displayed on the business card folder interface 800, and an option of “Share and save to a social relationship database” is provided in an information display section of the electronic business card. The user A may trigger the option to share the electronic business card of the user C and save the same to the above-mentioned social relationship database of the enterprise AA, such that the electronic business card of the user C may be viewed by other members in the enterprise AA. Certainly, the user A may choose not to share the electronic business card of the user C, depending on the user A's actual needs.

FIG. 13B is a schematic diagram of applying for a business card access permission according to an example embodiment. Assuming that a user X is a member of the enterprise AA, when browsing the social relationship database of the enterprise AA, the user X may view the electronic business card of the user C shared by the user A. For example, the user X may view a business card information display interface 1300B shown in FIG. 13B. The business card information display interface 1300 is used to display content of the electronic business card of the user C.

In an embodiment, the user X may view only some business card information of the user C on the business card information display interface 1300B, such as the name, the enterprise with which the user C is affiliated, the job title, the characteristic label, or the description information. Business card information such as the mobile phone number or the e-mail address is in an invisible state. A permission application option 1302B may be provided on the business card information display interface 1300B. The user X may initiate a permission acquiring request for the electronic business card of the user C to the server 102 by triggering the permission application option 1302B. Accordingly, the server 102 may pre-record an association relationship between the electronic business card of the user A and the electronic business card of the user C (for example, the association relationship may be established when the user A shares the electronic business card of the user C and saves the same to the above-mentioned social relationship database), and determine, based on the association relationship when receiving the permission acquiring request initiated by the user X, that a request object of the permission acquiring request is the user A. The server 102 may then forward the permission acquiring request to the user A, such that the user A reviews the request and makes a response thereto.

FIG. 13C is a schematic diagram of reviewing a permission acquiring request according to an example embodiment. The user A may view a review interface 1300C shown in FIG. 13C. The review interface 1300C may display information such as a requester (namely the person sending in the request) of a permission acquiring request or a requested electronic business card (namely the object being requested). For example, the user X requests to view the electronic business card of the user C. The user A may respectively view information of the user X and the user C (for example, at least some the content of the electronic business cards of the two) to learn about related information, and determine whether to accept the permission acquiring request initiated by the user X. When the user A accepts the request, the user X may view all the content of the electronic business card of the user C; otherwise, the user X may only view some of the content shown in FIG. 13B.

In an embodiment, the user X needs to meet a certain condition before browsing the social relationship database of the enterprise AA is made possible. For example, when determining that the number of the electronic business cards that the user X shares and saves to the social relationship database has reached a preset quantity, the server 102 may grant the user X a browsing permission for the social relationship database; otherwise, the user X may not browse electronic business cards in the social relationship database (not only that the information such as phone numbers and e-mail addresses are not viewable, user X will in fact not be able to view any information of the electronic business cards). Herein, when a browsing permission is granted to the user X, the user X may be directly granted with the browsing permissions for all the electronic business cards. Or the browsing permissions may have various levels, which are positively correlated with the quantity of electronic business cards shared by the user X. That is, a larger quantity of electronic business cards shared by the user X leads to a higher level of the acquired browsing permission. Accordingly, a higher level of the browsing permission means that the user X may view more electronic business cards (such as the total number or the daily viewed number of the electronic business cards).

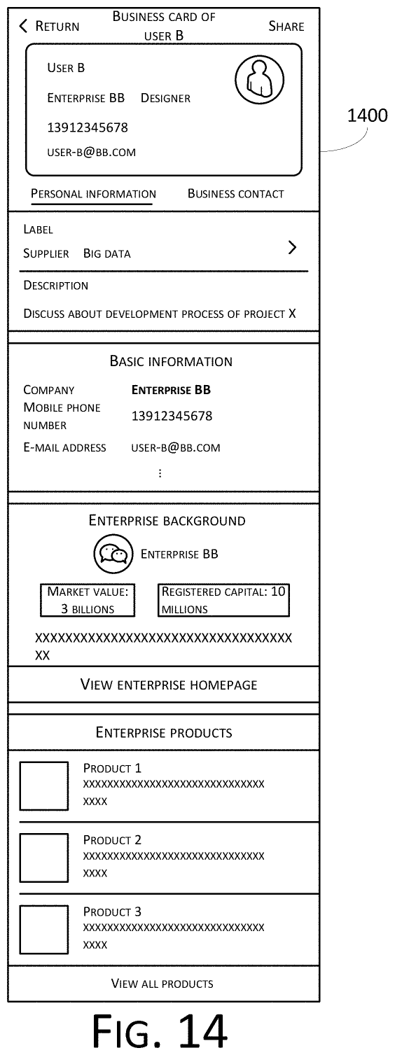

FIG. 14 is a schematic diagram of a business card details interface according to an example embodiment. Electronic business card information displayed in the above-mentioned embodiment includes only some content of an electronic business card. However, a business card details interface 1400 shown in FIG. 14 is used to display all of the content of the electronic business card. Taking the electronic business card of the user B for example. The business card details interface 1400 may include personal introduction information of the user B, such as the name, the profile photo, the company with which the user B is affiliated, the mobile phone number, the e-mail address, etc., and may further display the label, the annotation, and the like added by the user A for the user B.

In an embodiment, in addition to the personal introduction information of the user B, the business card details interface 1400 may further include enterprise introduction information of an enterprise BB affiliated with the user B. For example, the enterprise introduction information displayed in FIG. 14 may include “company background”, “company products”, and the like of the enterprise BB, which is not limited by the present disclosure. By displaying the enterprise introduction information, the embodiment enables the user A to quickly learn about the situation related to the enterprise BB with which the user B is affiliated in the process of viewing the electronic business card of the user B, thereby helping the user A to have a better understanding of the user B.

The business card details interface 1400 may include a “View enterprise homepage” option. When the user A is interested in the enterprise BB, the user A may trigger the “View enterprise homepage” option such that the business card details interface 1400 of the mobile phone 106 is switched to an enterprise homepage interface of the enterprise BB, thus helping the user A to learn more about detailed information of the enterprise BB.

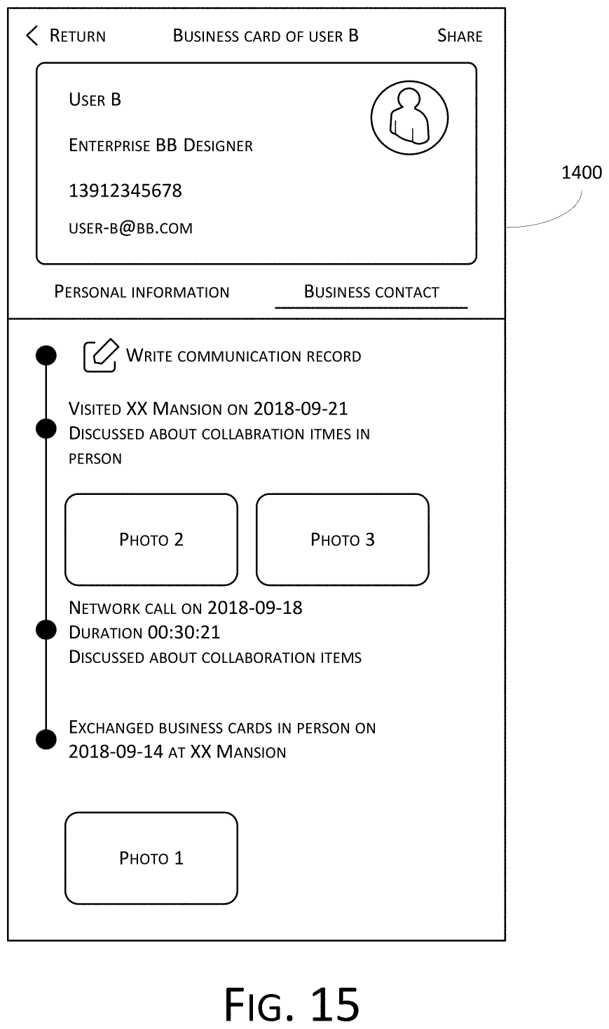

FIG. 15 is a schematic diagram of recording communication information according to an example embodiment. The business card details interface 1400 includes more label pages such as “Personal information”, “Business contact”, and the like. When the user A selects the “Business contact” label, the displayed interface content may be switched to what is shown in FIG. 15. In an embodiment, contact information between the user A and the user B may be recorded on the business card details interface 1400 for the user B. For example, a contact event of an “exchange business cards in person” occurred at “XX Mansion on 2018-Sep.-14”, and event description information such as a related photo 1 may be added. For another example, a communication event of a “network call” occurred on 2018-Sep.-18 with a call duration being 00:30:21, and event description information such as “discussion about collaborating items” may be added. For still another example, a communication event of a “visit” occurred at “XX Mansion on 2018-Sep.-21”, and event description information such as “discussion about collaborating items in person” and photos 2 and 3 may be added. When another communication event subsequently occurs, the user A may trigger a “Write a communication record” option shown in FIG. 15 to enter related contact information with the user B.

In an embodiment, the contact information shown in FIG. 15 may be manually entered by the user A, or may be automatically generated by the mobile phone 106 or the server 102. For example, after a communication event of exchanging business cards in person takes place, communication information of the “exchange business cards in person” occurred at “XX Mansion on 2018-Sep.-14” may be automatically generated according to the exchange time and the exchange location; and the user A may choose to add the photo 1 as the corresponding event description information. For another example, after a communication event of a network call with the user B takes place, communication information of the “network call” occurred on “2018-Sep.-18” may be automatically generated according to the call time and the call duration; and the user A may choose to add a text “discussion about collaborating items” and the like as the corresponding event description information.

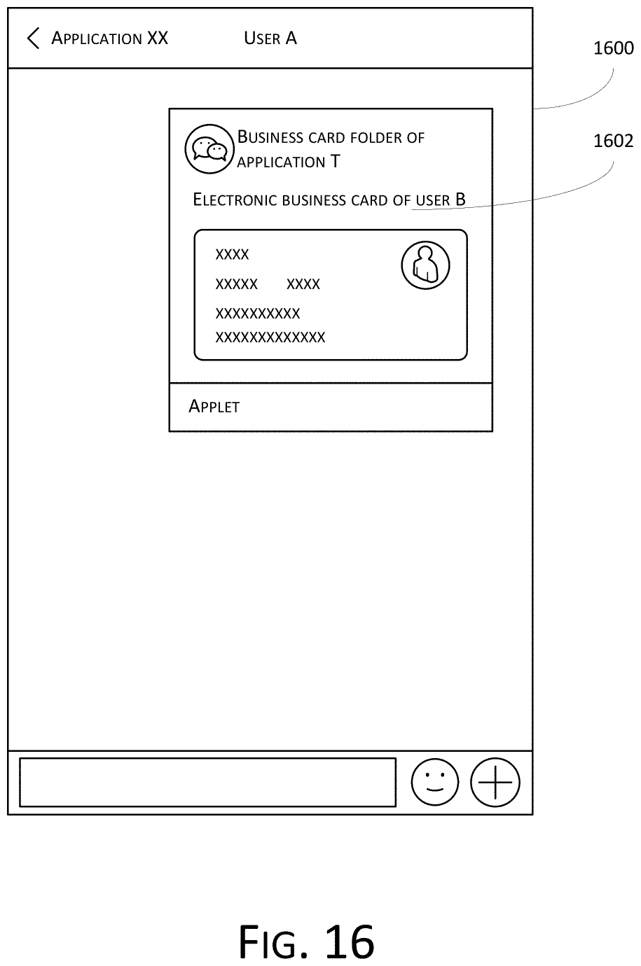

FIG. 16 is a schematic diagram of exchanging electronic business cards across applications according to an example embodiment. The user B may share the electronic business card thereof to the user A in the application XX, which may be achieved by using an applet function supported by the application XX. The applet function runs based on the application XX and may implement at least some functions of the application T. As shown in FIG. 16, a shared electronic business card may be displayed in a form of a communication session message 1602 on a communication session interface 1600 between the user A and the user B.

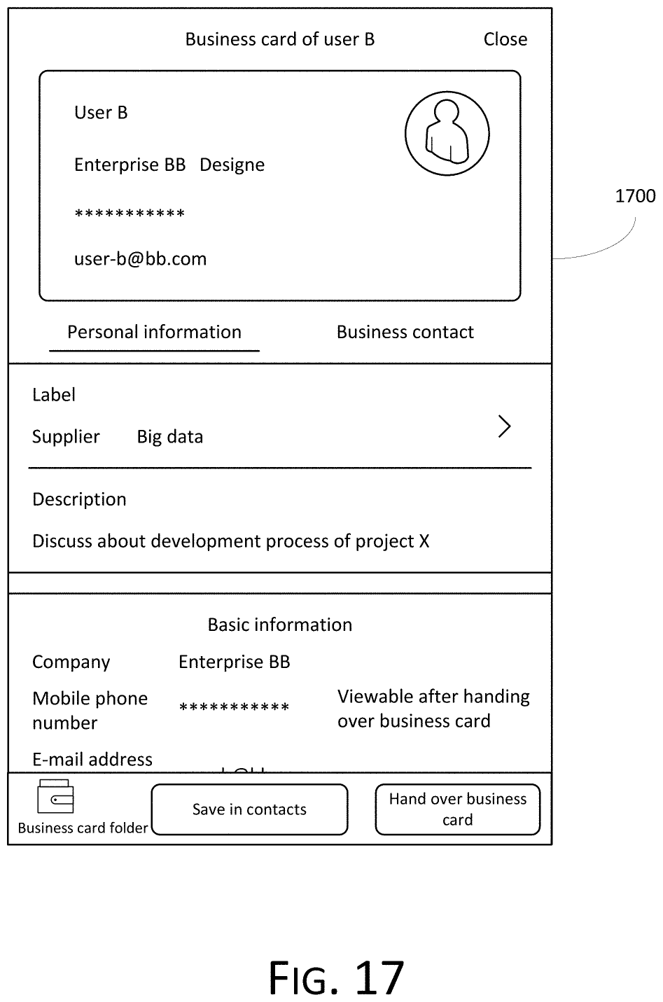

FIG. 17 is a schematic diagram of viewing content of an electronic business card according to an example embodiment. In response to an operation of triggering the communication session message 1602 by the user A, a content display interface 1700 shown in FIG. 17 may be displayed, such that detailed content of the electronic business card of the user B may be displayed. The content display interface 1700 is similar to the above-mentioned business card details interface 1400. Details are not elaborated herein again.

In an embodiment, when the user A only receives the electronic business card of the user B without sharing his own electronic business card, private content such as the mobile phone number on said electronic business card may be in a hidden state. For example, the hidden mobile phone number is indicated in FIG. 17 with “***********”. A text like “viewable after handing over a business card” is then used to prompt the user A to send the electronic business card thereof to the other party, such that the mobile phone number is no longer in a hidden state. Accordingly, the user A may send the electronic business card thereof to the user B by triggering a “Hand over business card” option at the bottom of the content display interface 1700, thereby completing the electronic business card exchange operation.

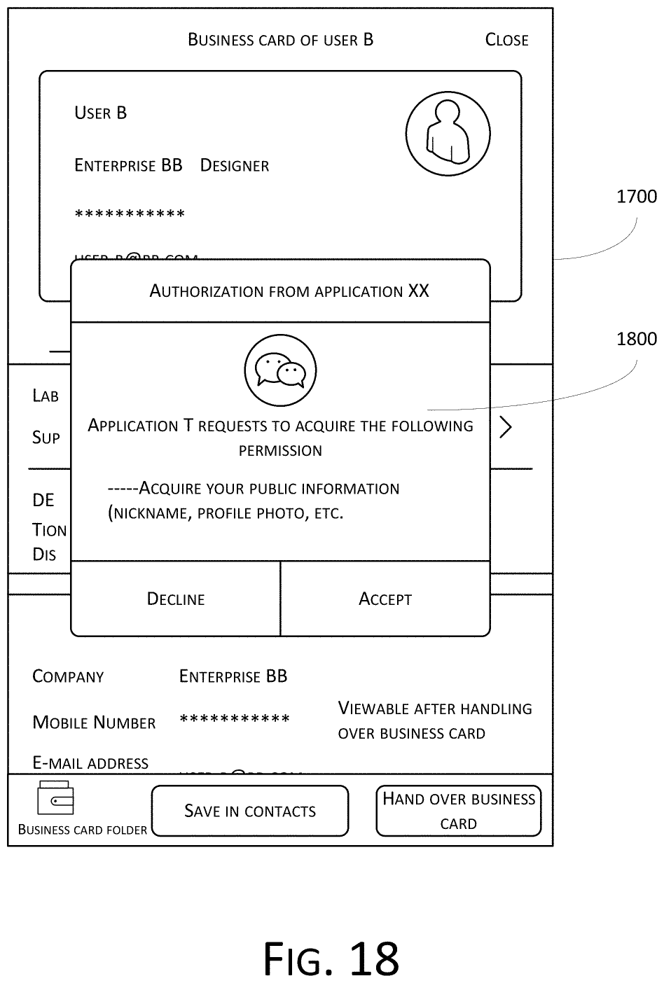

FIG. 18 is a schematic diagram of cross-application authorization according to an example embodiment. In response to an operation of triggering the above-mentioned “Hand over business card” option, the electronic business card of the user A may be sent to the user B by using the applet function, provided that the user A confirms authorization of the application T in the application XX. For example, an authorization window 1800 shown in FIG. 18 may be displayed and whether to grant the authorization is confirmed based on the user A's decision. After the authorization is granted, the above-mentioned operation of sending the electronic business card is performed.

Further, if the user A has not created an electronic business card on the application T, the applet function may first guide the user A to create an electronic business card; if the user A has not registered a user account on the application T, the applet function may first guide the user A to create a user account, and then further create and send the electronic business card.

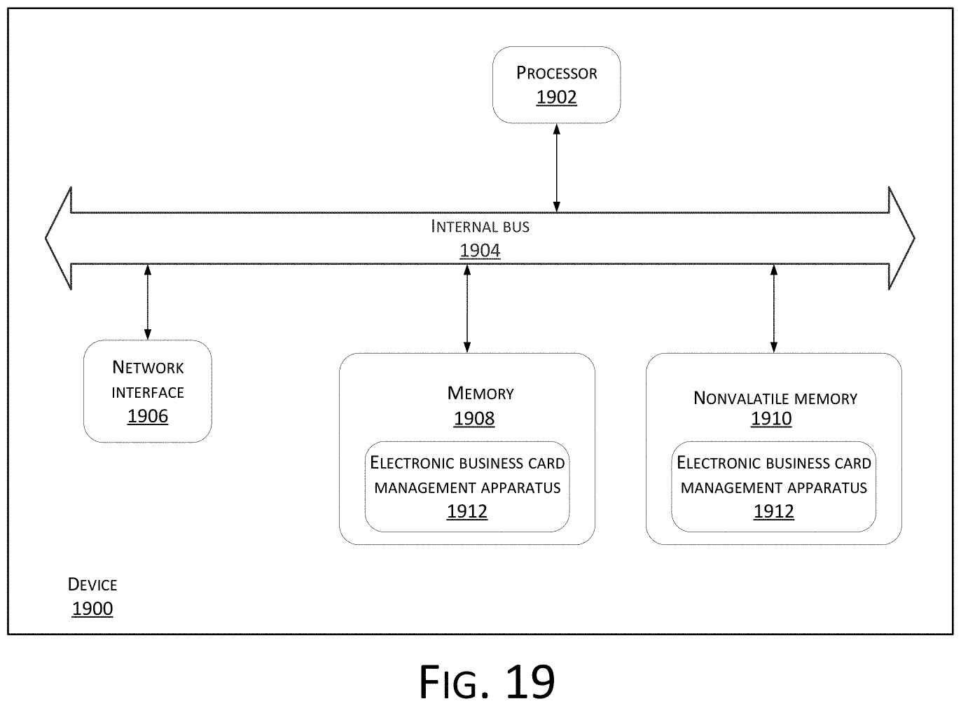

FIG. 19 is a schematic structural diagram of a device according to an example embodiment. Please refer to FIG. 19. A device 1900 includes a processor 1902, an internal bus 1904, a network interface 1906, a memory 1908, and a non-volatile memory 1910, and may certainly further include hardware required for other services. The processor 1902 reads a corresponding computer program from the non-volatile memory 1910 to the memory 1908 and then runs the corresponding computer program, thus forming an electronic business card management apparatus 1912. Certainly, in addition to a software implementation manner, one or more embodiments of the present disclosure do not exclude other implementation manners, such as a logic device or a combination of software and hardware. In other words, an execution body of the following processing procedure is not limited to each logic unit, and may also be hardware or a logic device.

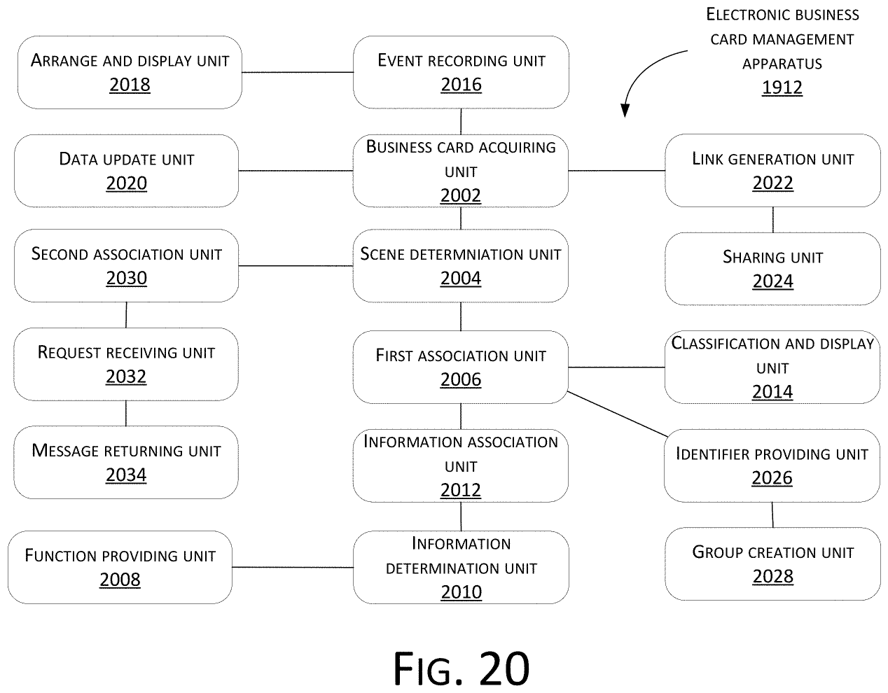

Please refer to FIG. 20. The electronic business card management apparatus 1912 may include the following units stored in the memory 1908 and the non-volatile memory 1910:
a business card acquiring unit 2002, configured to acquire an electronic business card;
a scene determination unit 2004, configured to determine corresponding scene information when the electronic business card is acquired; and
a first association unit 2006, configured to associate the electronic business card with the corresponding scene information.

For example, the business card acquiring unit 2002 is specifically configured to implement at least one of the following:
receiving an electronic business card proactively sent by an adjacent electronic device;
proactively sending to the adjacent electronic device an electronic business card of a local user, and receiving an electronic business card returned by the adjacent electronic device;
acquiring an electronic business card of a user having logged onto the adjacent electronic device from the adjacent electronic device or a server based on a verification code related to the adjacent electronic device; and
creating a corresponding electronic business card according to a scanning result of information on a paper business card.

For example, the scene information includes at least one of the following: a time, a location, and a pre-planned event related to the time and/or the location.

For example, the electronic business card management apparatus 1912 may further include the following units stored in the memory 1908 and the non-volatile memory 1910:
a function providing unit 2008, configured to provide a local user with a unified marking function for all electronic business cards covered by the scene information;
an information determination unit 2010, configured to determine a unified characteristic label and/or unified annotation information set by the local user; and
an information association unit 2012, configured to associate the unified characteristic label and/or the unified annotation information with all the electronic business cards covered by the scene information.

For example, the electronic business card management apparatus 1912 may further include the following units stored in the memory 1908 and the non-volatile memory 1910:
a classification and display unit 2014, configured to classify and display acquired electronic business cards according to the scene information.

For example, the electronic business card management apparatus further includes:
an event recording unit 2016, configured to record an interaction events between a local user and a target user corresponding to the electronic business card; and
an arrange and display unit 2018, configured to arrange and display on a display interface corresponding to the electronic business card the interaction events in accordance with a time sequence of occurrences.

For example, the interaction events include at least one of the following: a business card transferring event, a communication event, and a visit event.

For example, the electronic business card management apparatus 1912 may further include the following units stored in the memory 1908 and the non-volatile memory 1910:
a data update unit 2020, configured to update data of the electronic business card according to business card updating data sent by a server, wherein
the business card updating data is related to a business card updating operation on the electronic business card performed by the target user.

For example, the electronic business card management apparatus further includes:
a link generation unit 2022, configured to generate a sharing link of the electronic business card; and
a sharing unit 2024, configured to send a target recipient user the sharing link or sharing content representing the sharing link.

For example, the electronic business card includes private content. The private content is hidden when the electronic business card of the local user is not sent to a target user corresponding to the electronic business card, and is displayed when the electronic business card of the local user is sent to the target user.

For example, the electronic business card management apparatus 1912 may further include the following units stored in the memory 1908 and the non-volatile memory 1910:
an identifier providing unit 2026, configured to provide a local user with communication identifiers for all the electronic business cards covered by the scene information; and
a group creation unit 2028, configured to create a corresponding communication group according to an operation of the local user triggering the communication identifiers, wherein members in the communication group comprise the local user and a target user corresponding to an electronic business card related to the scene information.

For example, the electronic business card management apparatus 1912 may further include the following units stored in the memory 1908 and the non-volatile memory 1910:
a second association unit 2030, configured to associate the electronic business card and the corresponding scene information with an organization with which the local user is affiliated.

For example, the electronic business card management apparatus 1912 may further include the following units stored in the memory 1908 and the non-volatile memory 1910:
a request receiving unit 2032, configured receive a permission acquiring request for the electronic business card initiated by any member in the organization, wherein when the any member has not acquired an access permission for the electronic business card, at least some content of the electronic business card is in a state hidden from the any member; and
a message returning unit 2034, configured to return a confirmation message for the permission acquiring request according to a confirmation operation of the local user, such that the access permission for the electronic business card is granted to the any member, and the hidden state is no longer concealed from the any member.

For example, an association relationship between the local user and the electronic business card is visible to the any member; and the request receiving unit 2032 is specifically configured to: receive the permission acquiring request for the electronic business card initiated by the any member to the local user; or
the association relationship is invisible to the any member; and the request receiving unit 2032 is specifically configured to: receive, from a server, the permission acquiring request, wherein after the permission acquiring request is sent by the any member to the server, the server forwards the permission acquiring request to the local user according to the association relationship.

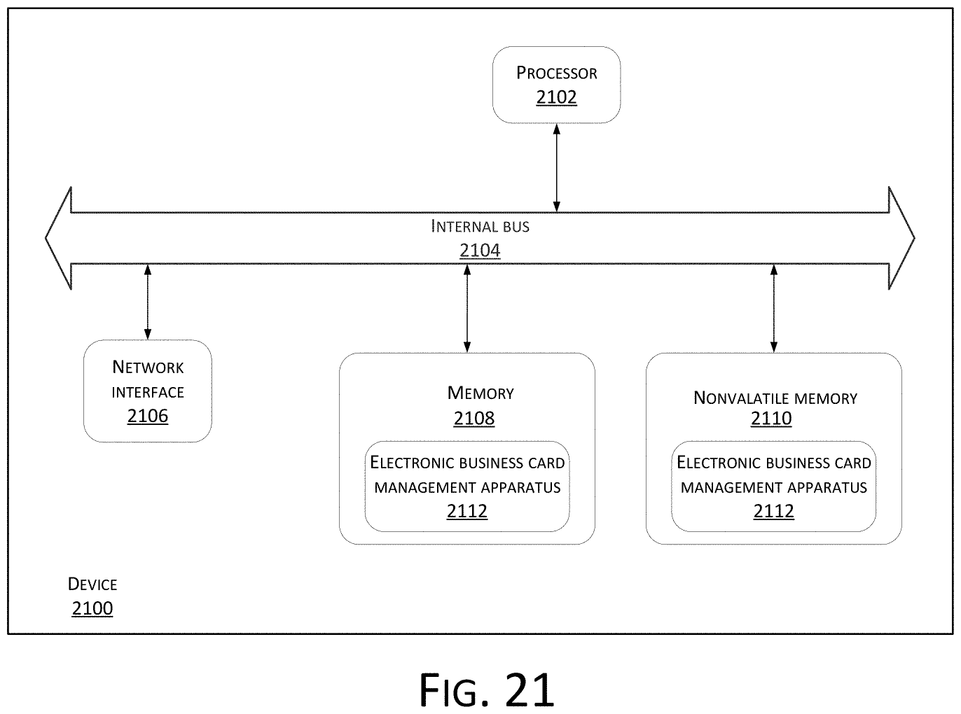

FIG. 21 is a schematic structural diagram of a device according to an example embodiment. Please refer to FIG. 21. A device 2100 includes a processor 2102, an internal bus 2104, a network interface 2106, a memory 2108, and a non-volatile memory 2110, and may certainly further include hardware required for other services. The processor 2102 reads a corresponding computer program from the non-volatile memory 2110 to the memory 2108 and then runs the corresponding computer program, thus forming an electronic business card management apparatus 2112. Certainly, in addition to a software implementation manner, one or more embodiments of the present disclosure do not exclude other implementation manners, such as a logic device or a combination of software and hardware. In other words, an execution body of the following processing procedure is not limited to each logic unit, and may also be hardware or a logic device.

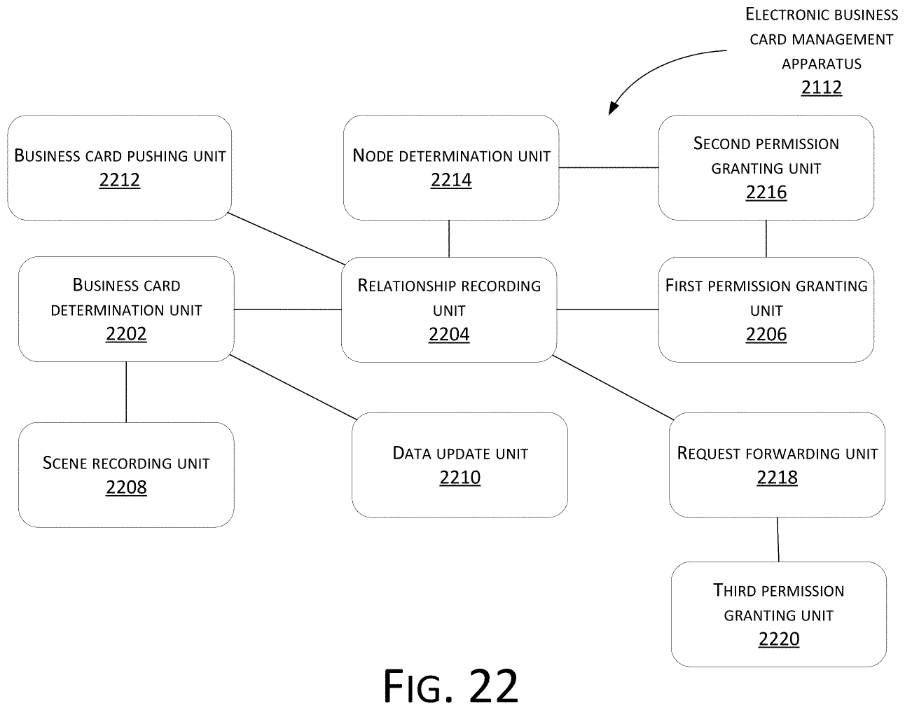

Please refer to FIG. 22. The electronic business card management apparatus 2112 may include the following units stored in the memory 2108 and the non-volatile memory 2110:
a business card determination unit 2202, configured to determine electronic business cards acquired by members in an organization;
a relationship recording unit 2204, configured to record a relationship between the electronic business cards and the organization; and
a first permission granting unit 2206, configured to set access permissions for the members in the organization for the electronic business cards according to the relationship.

For example, the electronic business card management apparatus further includes:
a scene recording unit 2208, configured to record corresponding scene information when the electronic business cards are acquired, wherein
the scene information is used to classify and display the electronic business cards.

For example, the scene information includes at least one of the following: a time, a location, and a pre-planned event related to the time and/or the location.

For example, the electronic business card management apparatus further includes:
a data update unit 2210, configured to update data of the electronic business cards according to a business card updating operation performed on the electronic business cards by a target user.

For example, the first permission granting unit 2206 is specifically configured to:
when any user joins the organization, granting the any user the access permissions for the electronic business cards; and
when the any user leaves the organization, canceling the access permissions of the any user for the electronic business cards.

For example, the relationship recording unit 2204 is specifically configured to: record a mapping relationship between the electronic business cards and an organization node corresponding to the member having acquired the electronic business cards in an organizational structure of the organization; and
the first permission granting unit 2206 is specifically configured to: grant a member corresponding to the association node in the organization access permissions for the electronic business cards.

For example, the electronic business card management apparatus 2112 may include the following units stored in the memory 2108 and the non-volatile memory 2110:
a business card pushing unit 2212, configured to, when the member corresponding to the organization node in the organization is changed, push an electronic business card of a member after the change to target users corresponding to the electronic business cards.

For example, the electronic business card management apparatus 2112 may include the following units stored in the memory 2108 and the non-volatile memory 2110:
a node determination unit 2214, configured to determine an association node related to the organization node in the organizational structure of the organization; and
a second permission granting unit 2216, configured to grant the member corresponding to the association node in the organization the access permissions for the electronic business cards.

For example, when any member in the organization has not acquired the access permission for the electronic business card, at least some content of the electronic business card is in a state hidden from the any member; and the apparatus further includes:
a request forwarding unit 2218, configured to forward the permission acquiring request to the member having acquired the electronic business card when a permission acquiring request for the electronic business card initiated by the any member is received; and
a third permission granting unit 2220, configured to grant the any member the access permission for the electronic business card according to a confirmation message returned by the member having acquired the electronic business card.

For example, an association relationship between the electronic business card and the member having acquired the electronic business card is visible to the any member; and a request object of the permission acquiring request is designated by the any member as the member having acquired the electronic business card; or
the association relationship is invisible to the any member; and the request forwarding unit 2218 is specifically configured to: when the permission acquiring request initiated by the any member for the electronic business card is received, forward, according to the association relationship, the permission acquiring request to the member having acquired the electronic business card.

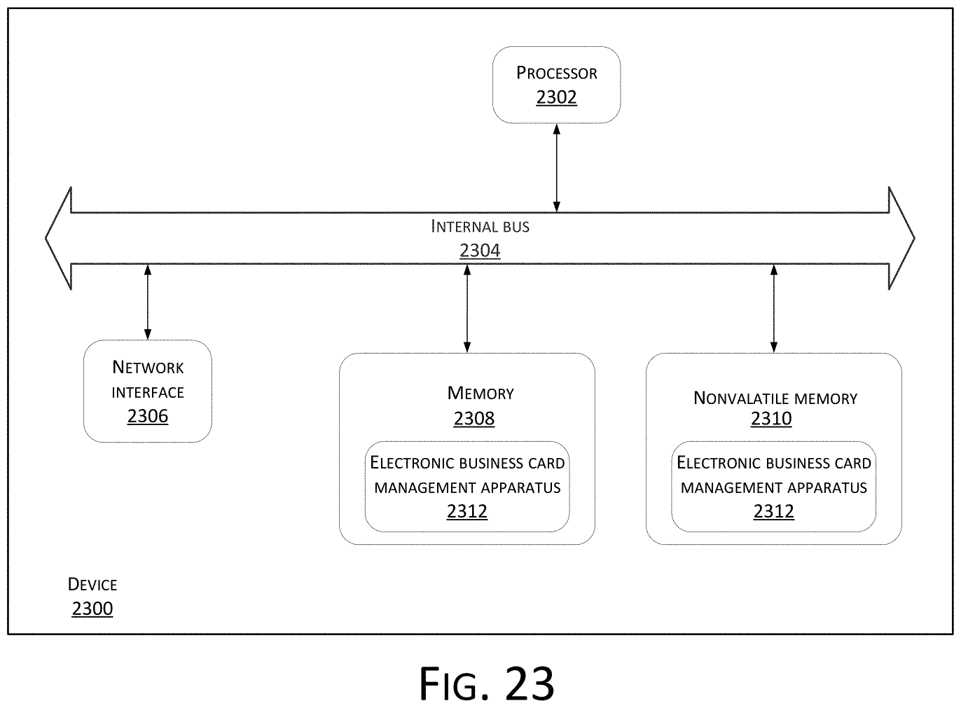

FIG. 23 is a schematic structural diagram of a device according to an example embodiment. Please refer to FIG. 23. A device 2300 includes a processor 2302, an internal bus 2304, a network interface 2306, a memory 2308, and a non-volatile memory 2310, and may certainly further include hardware required for other services. The processor 2302 reads a corresponding computer program from the non-volatile memory 2310 to the memory 2308 and then runs the corresponding computer program, thus forming an electronic business card management apparatus 2312. Certainly, in addition to a software implementation manner, one or more embodiments of the present disclosure do not exclude other implementation manners, such as a logic device or a combination of software and hardware. In other words, an execution body of the following processing procedure is not limited to each logic unit, and may also be hardware or a logic device.

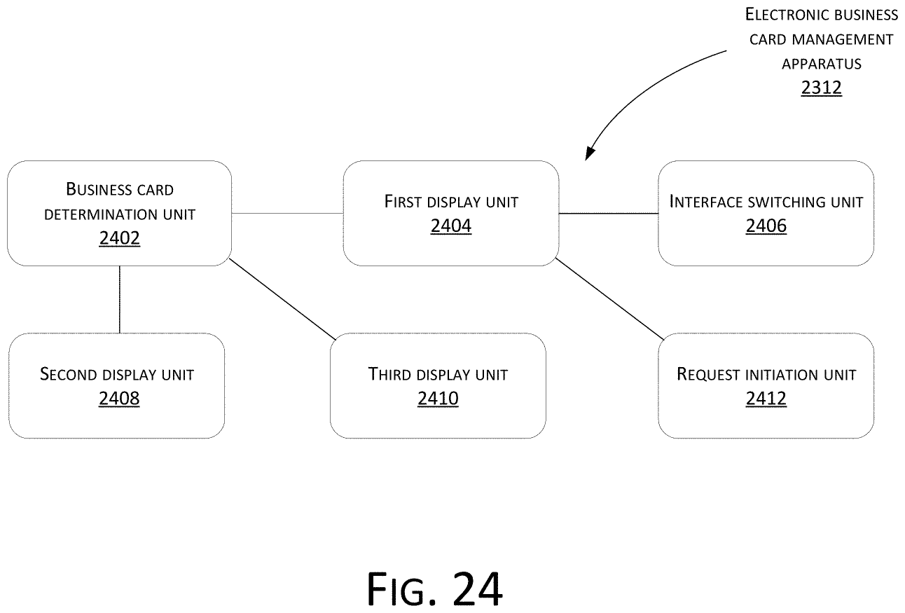

Please refer to FIG. 24. The electronic business card management apparatus 2312 may include the following units stored in the memory 2308 and the non-volatile memory 2310:
a business card determination unit 2402, configured to determine a selected electronic business card; and
a first display unit 2404, configured to display, on a content display interface of the electronic business card, personal introduction information of a target user corresponding to the electronic business card and organization introduction information of an organization with which the target user is affiliated.

For example, the electronic business card management apparatus 2312 may include the following units stored in the memory 2308 and the non-volatile memory 2310:
an interface switching unit 2406, configured to switch, according to an operation of triggering the organization introduction information, to an organization homepage interface corresponding to the organization with which the target user is affiliated.

For example, the organization introduction information includes brief introduction information of the organization with which the target user is affiliated, and the organization homepage interface includes detailed introduction information of the organization with which the target user is affiliated.

For example, the electronic business card is acquired using any one of the following manners:
receiving an electronic business card proactively sent by an adjacent electronic device;
proactively sending to the adjacent electronic device an electronic business card of a local user, and receiving an electronic business card returned by the adjacent electronic device;
acquiring an electronic business card of a user having logged onto the adjacent electronic device from the adjacent electronic device or a server based on a verification code related to the adjacent electronic device; and
creating a corresponding electronic business card according to a scanning result of information on a paper business card.

For example, the electronic business card management apparatus 2312 may further include the following units stored in the memory 2308 and the non-volatile memory 2310:
a second display unit 2408, configured to display, on the content display interface of the electronic business card, corresponding scene information when the electronic business card is acquired.

For example, the scene information includes at least one of the following: a time, a location, and a pre-planned event related to the time and/or the location.

For example, the electronic business card management apparatus 2312 may further include the following units stored in the memory 2308 and the non-volatile memory 2310:
a third display unit 2410, configured to display, on the content display interface of the electronic business card, a characteristic label and/or annotation information marked by a local user for the electronic business card.

For example, after the electronic business card is acquired by a specific member in an organization with which a local user is affiliated, the electronic business card is associated with the organization with which the local user is affiliated; and the apparatus further comprises: a request initiation unit 2412, configured to initiate a permission acquiring request for the electronic business card to a server, so that the server forwards the permission acquiring request to the specific member according to an association relationship between the specific member and the electronic business card, such that the specific member determines whether to grant the local user an access permission for the electronic business card; and
the first display unit 2404 is specifically configured to: when the local user has acquired the access permission, display all content of the personal introduction information; and when the local user has not acquired the access permission, display some of the content of the personal introduction information, such that at least some content of the personal introduction information is in a hidden state.

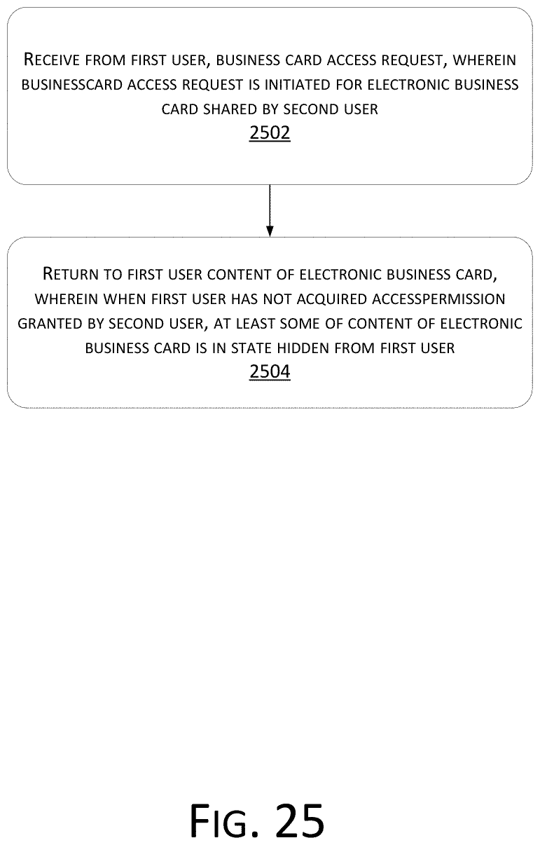

FIG. 25 is a flowchart of an electronic business card management method according to example embodiment IV. As shown in FIG. 25, the method is applied to a server (such as the server 102 shown in FIG. 1), and may include the following steps:

Step 2502. Receive, from a first user, a business card access request, wherein the business card access request is initiated for an electronic business card shared by a second user.

In an embodiment, the first user may initiate the business card access request to the server by using a client running on an electronic device used by the first user.

In an embodiment, the first user may initiate the above-mentioned business card access request without a specific goal, and an electronic business card shared by the second user happens to belong to a request object of the business card access request. Therefore, it may be considered that the business card access request is initiated for the electronic business card shared by the second user. For example, when a trigger instruction sent by the first user is used to enter a business card list interface, it may be considered that sending of the trigger instruction means that the first user initiates the business card access request. When the electronic business card shared by the second user happens to be on the business card list interface, it may be determined that the business card access request is initiated for the electronic business card shared by the second user. In other words, when the business card access request is initiated for the electronic business card shared by the second user, it does not necessarily mean that the business card access request is used to only acquire the electronic business card shared by the second user. There is no one-to-one correspondence between the two.

In an embodiment, the first user may specify the electronic business card shared by the second user as the request object, and initiate the corresponding business card access request. For example, the client running on the electronic device used by the first user may display a business card list that includes summary information or index information of several electronic business cards. The first user may trigger one or more business cards in the business card list, so as to initiate a business card access request. If triggered electronic business cards include the electronic business card shared by the second user, it may be considered that the business card access request is initiated for the electronic business card shared by the second user. In other words, the business card access request may be initiated only for the electronic business card shared by the second user, or it may be initiated for both the electronic business card shared by the second user and other electronic business cards, which is not limited by the present disclosure.

In an embodiment, the business card access request may be initiated for one or more electronic business cards shared by the second user. The quantity of the electronic business cards is not limited by the present disclosure.

In an embodiment, the first user and the second user may belong to the same organization. The second user may share an electronic business card and save the same to a social relationship database related to the organization. The first user, as a member in the same organization, may acquire an access permission for the social relationship database, so as to initiate a business card access request for electronic business cards in the social relationship database after having accessed the social relationship database, such that content of these electronic business cards may then be accessed.

In an embodiment, the electronic business card may include virtual information for realizing a business card function. The information content of the electronic business card may be formed by combining one or more types of a text, a picture, an audio, a video, and the like, which is not limited by the present disclosure.

In an embodiment, the second user may acquire the electronic business card in any manner, which is not limited by the present disclosure.

For example, an electronic device used by the second user may receive an electronic business card proactively sent by an adjacent electronic device. In other words, an operation of sending the electronic business card may be triggered and implemented unilaterally. For another example, the electronic device used by the second user may proactively send an electronic business card of a local user to the adjacent electronic device, and receive an electronic business card returned by the adjacent electronic device. In other words, electronic business cards are to be sent to each other based on an exchange principle.

Here, sending an electronic business card between the electronic device used by the second user and the adjacent electronic device may be implemented in more manners. For example, the electronic device used by the second user may establish a near field communication connection with the adjacent electronic device based on Bluetooth, Wi-Fi, or the like, or the electronic device used by the second user may establish a remote communication connection with the adjacent electronic device (for example, based on a mobile communication technology such as 4G or 5G). In this way, the electronic device used by the second user may acquire an electronic business card through the near field communication connection or the remote communication connection. In the technical solution based on the remote communication connection, the electronic device used by the second user may proactively request for an electronic business card from the adjacent electronic device, or the adjacent electronic device may proactively send an electronic business card to the electronic device, or a server may proactively push an electronic business card of the adjacent electronic device to the electronic device used by the second user when determining that the electronic device used by the second user is geographically close to the adjacent electronic device (for example, the determination may be performed based on GPS positioning data, or based on a connected Wi-Fi hotspot when the location of the Wi-Fi hotspot is known, or based on a nearby Bluetooth beacon when the location of the Bluetooth beacon is known).

For another example, an electronic business card of a user having logged onto the adjacent electronic device may be acquired from the adjacent electronic device or the server based on a verification code related to the adjacent electronic device. For example, after the adjacent electronic device generates a verification code related to sharing the electronic business card, the second user may enter the verification code on the electronic device used by the second user or the electronic device used by the second user may directly scan the verification code. Then the electronic device used by the second user may send a verification request including the verification code to the adjacent electronic device or the server. After the adjacent electronic device or the server performs verification and the verification succeeds, the electronic business card of the user having logged onto the adjacent electronic device is acquired. In this way, randomly sending electronic business cards may then be confined.

In an embodiment, the electronic device used by the second user may create a corresponding electronic business card based on a result of scanning information of a paper business card. For example, the electronic device used by the second user may scan the paper business card (i.e., a traditional business card, the material of which may also be plastic or any other material, which is not limited to paper) by using a camera, so as to recognize content of the business card based on OCR technology and the like, organize the recognition result in a preset format, and create a corresponding electronic business card.

Step 2504. Return to the first user content of the electronic business card, wherein when the first user has not acquired an access permission granted by the second user, at least some of the content of the electronic business card is in a state hidden from the first user.

In an embodiment, how much of the electronic business card that the second user shares may be viewed by the first user can be controlled by identifying if the first user has acquired the access permission. In this way, when the first user has not acquired the consent and authorization from the second user, the first user may only view basic content such as names and job titles and is unable to view at least some other content such as contact information. As a result, the second user is in control of sharing the electronic business card.

In an embodiment, a sharing relationship between the second user and the electronic business card shared by the second user is invisible to the first user. The server may receive the permission acquiring request initiated by the first user for the electronic business card, and forward the permission acquiring request to the second user according to the sharing relationship between the second user and the electronic business card. Then, the server may grant the first user the access permission according to a confirmation message returned by the second user, such that the hidden state is no longer concealed from said user. In other words, the first user may seek the consent and authorization from the second user by initiating the permission acquiring request to the second user. After the consent and authorization are acquired from the second user, all of the content of the electronic business card shared by the second user may be viewed. As a result, the second user is in control of sharing the electronic business card. Although the first user is not aware of the above-mentioned sharing relationship, the first user only needs to specify to the server the electronic business card for which the permission acquiring request is made. The server may then determine the corresponding second user based on the sharing relationship, thereby accurately forwarding the permission acquiring request to the second user.

In an embodiment, when the server forwards the permission acquiring request to the second user, information of the first user may be notified to the second user, such that the second user may be fully aware of the source of the permission acquiring request, and determine whether to grant the authorization.

In an embodiment, the permission acquiring request may be independently initiated for each electronic business card or simultaneously initiated for multiple electronic business cards. The multiple electronic business cards may be shared by the same user, and the first user may initiate a permission acquiring request to the user. Alternatively, the multiple electronic business cards may be shared by multiple users, and the first user may initiate a permission acquiring request for each of the multiple users.

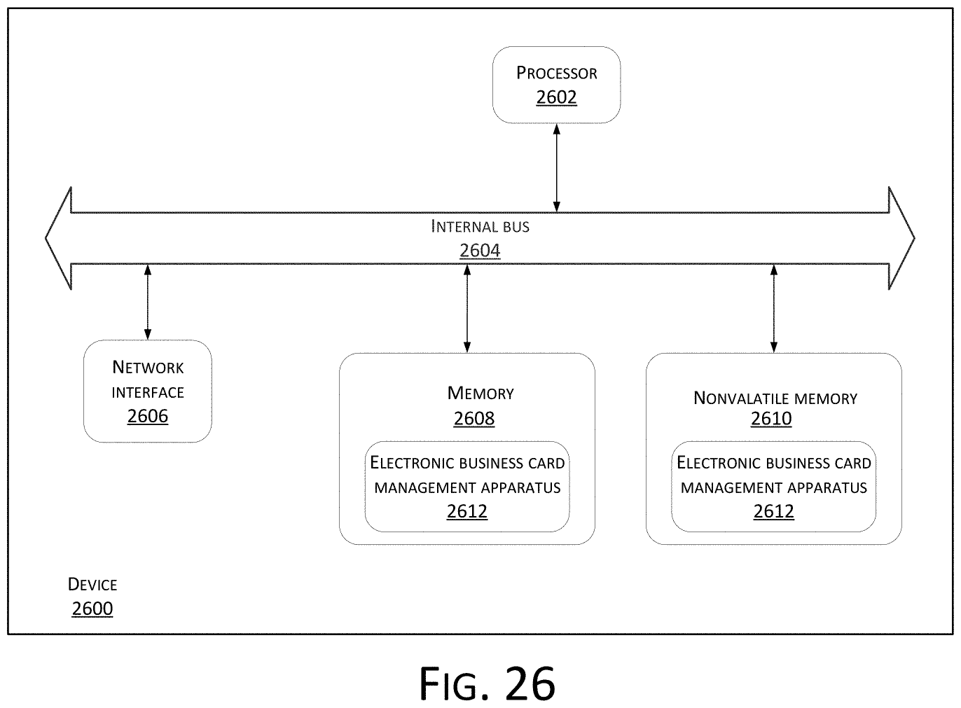

FIG. 26 is a schematic structural diagram of a device according to an example embodiment. Please refer to FIG. 26. A device 2600 includes a processor 2602, an internal bus 2604, a network interface 2606, a memory 2608, and a non-volatile memory 2610, and may certainly further include hardware required for other services. The processor 2602 reads a corresponding computer program from the non-volatile memory 2610 to the memory 2608 and then runs the corresponding computer program, thus forming an electronic business card management apparatus 2612. Certainly, in addition to a software implementation manner, one or more embodiments of the present disclosure do not exclude other implementation manners, such as a logic device or a combination of software and hardware. In other words, an execution body of the following processing procedure is not limited to each logic unit, and may also be hardware or a logic device.

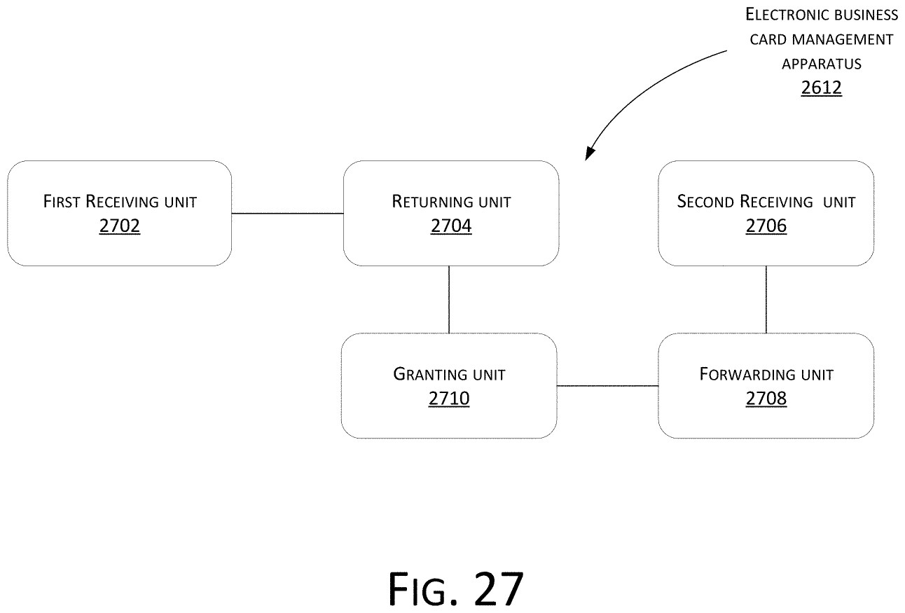

Please refer to FIG. 27. The electronic business card management apparatus 2612 may further include the following units stored in the memory 2608 and the non-volatile memory 2610:
a first receiving unit 2702, configured to receive, from a first user, a business card access request, wherein the business card access request is initiated with regard to an electronic business card shared by a second user; and
a returning unit 2704, configured to return to the first user content of the electronic business card, wherein when the first user has not acquired an access permission granted by the second user, at least some of the content of the electronic business card is in a state hidden from the first user.

For example, the electronic business card management apparatus 2612 may further include the following units stored in the memory 2608 and the non-volatile memory 2610:
a second receiving unit 2706, configured to receive a permission acquiring request for the electronic business car initiated by the first user;
a forwarding unit 2708, configured to forward the permission acquiring request to the second user according to a sharing relationship between the second user and the electronic business card; and
a granting unit 2710, configured to grant the first user the access permission according to a confirmation message returned by the second user, such that the hidden state is no longer concealed from the user.

Systems, apparatuses, modules, or units described in the above-described embodiments may be specifically implemented by computer chips or entities, or by products with a certain function. A typical implementation device is a computer. A specific form of the computer may be a personal computer, a laptop computer, a cellular phone, a camera phone, a smart phone, a personal digital assistant, a media player, a navigation device, an e-mail transceiver, a game console, a tablet computer, a wearable device, or a combination of any of these devices.

In a typical configuration, the computer includes one or more processors (CPU), an input/output interface, a network interface, and a memory.

The memory may include a volatile memory on a computer-readable medium, a random-access memory (RAM) and/or a non-volatile memory, and the like, such as a read-only memory (ROM) or a flash random access memory (flash RAM). The memory is an example of the computer-readable medium.

Computer-readable media further include nonvolatile and volatile, removable and non-removable media employing any method or technique to achieve information storage. The information may be computer readable instructions, data structures, modules of programs, or other data. Examples of computer storage media include, but are not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical memories, a magnetic cassette tape, a magnetic disk storage, a quantum memory, a graphene-based storage medium or other magnetic storage devices or any other non-transmission medium, which may be used to store information that can be accessed by a computing device. As defined herein, the computer-readable media do not include transitory media, such as modulated data signals and carriers

It should be further noted that the terms “include”, “comprise” or any other variants thereof are intended to encompass non-exclusive inclusion, so that a process, method, product, or device that involves a series of elements comprises not only those elements, but also other elements not explicitly listed, or elements that are inherent to such a process, method, product, or device. Unless more limitations are stated, an element defined by the phrase “including a . . . ” does not exclude the existence of another identical element in the process, method, product, or device that includes the element.

The above-mentioned describes specific embodiments of the present disclosure. Other embodiments fall within the scope of the appended claims. In some cases, the actions or steps stated in the claims may be performed in a sequence different from those in the embodiments and the desired result can still be achieved. In addition, the processes described in the accompanying drawings do not necessarily require the specific order or sequential order shown to achieve the desired result. In some implementation manners, multitasking and parallel processing are also feasible or may be advantageous.

The terms used in one or more embodiments of the present disclosure are only for the purpose of describing specific embodiments, and are not intended to limit one or more embodiments of the present disclosure. Unless the context clearly dictates otherwise, the singular forms “a”, “an”, “said” and “the” used in one or more embodiments of the present disclosure and the appended claims are also intended to include the plural forms. It should also be appreciated that the term “and/or” used herein refers to and includes any or all possible combinations of one or more associated listed items.

It should be appreciated that, although the terms “first”, “second”, “third”, and the like may be used to describe various information in one or more embodiments of the present disclosure, such information should not be limited to these terms. These terms are only used to distinguish the same type of information from each other. For example, without departing from the scope of one or more embodiments of the present disclosure, first information may also be referred to as second information. Similarly, the second information may also be referred to as the first information. Depending on the context, the word “if” as used herein may be interpreted as “when” or “in the case that” or “in response to a determination”.

The above-mentioned are only example embodiments of one or more embodiments of the present disclosure, and are not intended to limit one or more embodiments of the present disclosure. Any modification, equivalent replacement, improvement, and the like made within the spirit and principle of one or plurality of embodiments of the present disclosure should fall within the protection scope of one or more embodiments of the present disclosure.

The present disclosure may further be understood with clauses as follows.

Clause 1. An electronic business card management method, comprising:
acquiring an electronic business card;
determining corresponding scene information when the electronic business card is acquired; and
associating the electronic business card with the corresponding scene information.

Clause 2. The method according to clause 1, wherein the acquiring the electronic business card comprises any one of the following:
receiving the electronic business card proactively sent by an adjacent electronic device;
proactively sending to the adjacent electronic device an electronic business card of a local user, and receiving an electronic business card returned by the adjacent electronic device;
acquiring, from the adjacent electronic device or a server based on a verification code related to the adjacent electronic device, an electronic business card of a user having logged onto the adjacent electronic device; and
creating a corresponding electronic business card according to a scanning result of information on a paper business card.

Clause 3. The method according to clause 1, wherein the scene information comprises at least one of the following: a time, a location, and a pre-planned event related to the time and/or the location.

Clause 4. The method according to clause 1, further comprising:
providing a local user with a unified marking function for all electronic business cards covered by the scene information;
determining a unified characteristic label and/or unified annotation information set by the local user; and
associating the unified characteristic label and/or the unified annotation information with all the electronic business cards covered by the scene information.

Clause 5. The method according to clause 1, further comprising:
classifying and displaying the acquired electronic business cards in accordance with the scene information.

Clause 6. The method according to clause 1, further comprising:
recording interaction events between a local user and a target user corresponding to the electronic business card; and
arranging and displaying on a display interface corresponding to the electronic business card the interaction events in accordance with a time sequence of occurrences.

Clause 7. The method according to clause 6, wherein the interaction events comprise at least one of the following: a business card transferring event, a communication event, or a visit event.

Clause 8. The method according to clause 1, further comprising:
updating data of the electronic business card according to business card updating data sent by a server, wherein
the business card updating data is related to a business card updating operation on the electronic business card performed by the target user.

Clause 9. The method according to clause 1, further comprising:
generating a sharing link of the electronic business card; and
sending to a target recipient user the sharing link or sharing content representing the sharing link.

Clause 10. The method according to clause 1, wherein the electronic business card comprises private content, wherein the private content is hidden when an electronic business card of a local user is not sent to a target user corresponding to the electronic business card, and is displayed when the electronic business card of the local user is sent to the target user.

Clause 11. The method according to clause 1, further comprising:
providing a local user with communication identifiers for all electronic business cards covered by the scene information; and
creating a corresponding communication group according to an operation of the local user triggering the communication identifiers, wherein members in the communication group comprise the local user and a target user corresponding to an electronic business card related to the scene information.

Clause 12. The method according to clause 1, further comprising:
associating the electronic business card and the corresponding scene information with an organization with which a local user is affiliated.

Clause 13. The method according to clause 12, further comprising:
receiving a permission acquiring request for the electronic business card initiated by any member in the organization, wherein when the any member has not acquired an access permission for the electronic business card, at least some content of the electronic business card is in a state hidden from the any member; and
returning a confirmation message for the permission acquiring request according to a confirmation operation of the local user, such that the access permission for the electronic business card is granted to the any member, and the hidden state is no longer concealed from the any member.

Clause 14. The method according to clause 13, wherein
an association relationship between the local user and the electronic business card is visible to the any member; and the receiving the permission acquiring request for the electronic business card initiated by any member in the organization comprises: receiving the permission acquiring request for the electronic business card initiated by the any member to the local user; or
the association relationship is invisible to the any member; and the receiving the permission acquiring request for the electronic business card initiated by any member in the organization comprises: receiving, from a server, the permission acquiring request, wherein after the permission acquiring request is sent by the any member to the server, the server forwards the permission acquiring request to the local user according to the association relationship.

Clause 15. An electronic business card management method, comprising:
determining electronic business cards acquired by members in an organization;
recording a relationship between the electronic business cards and the organization; and
setting access permissions for the members in the organization for the electronic business cards according to the relationship.

Clause 16. The method according to clause 15, further comprising:
recording corresponding scene information when the electronic business cards are acquired, wherein
the scene information is used to classify and display the electronic business cards.

Clause 17. The method according to clause 16, wherein the scene information comprises at least one of the following: a time, a location, and a pre-planned event related to the time and/or the location.

Clause 18. The method according to clause 15, further comprising:
updating data of the electronic business cards according to a business card updating operation performed on the electronic business cards by a target user.

Clause 19. The method according to clause 15, wherein the setting the access permission of the members in the organization for the electronic business cards according to the relationship comprises:
when any user joins the organization, granting the any user the access permissions for the electronic business cards; and
when the any user leaves the organization, canceling the access permissions of the any user for the electronic business cards.

Clause 20. The method according to clause 15, wherein
the recording a relationship between the electronic business cards and the organization comprises: recording a mapping relationship between the electronic business cards and an organization node corresponding to the member having acquired the electronic business cards in an organizational structure of the organization; and
the setting the access permission of the members in the organization for the electronic business cards according to the relationship comprises: granting the member corresponding to the organization node in the organization the access permissions for the electronic business cards.

Clause 21. The method according to clause 20, further comprising:
when the member corresponding to the organization node in the organization is changed, pushing an electronic business card of a member after the change to target users corresponding to the electronic business cards.

Clause 22. The method according to clause 20, further comprising:
determining an association node related to the organization node in the organizational structure of the organization; and
granting members corresponding to the association node in the organization access permissions for the electronic business cards.

Clause 23. The method according to clause 15, wherein when any member in the organization has not acquired the access permission for the electronic business card, hiding at least some content of the electronic business card from the any member; and the method further comprises:

Forwarding the permission acquiring request to the member having acquired the electronic business card when a permission acquiring request for the electronic business card initiated by the any member is received; and
granting the any member the access permission for the electronic business cards according to a confirmation message returned by the member having acquired the electronic business card.

Clause 24. The method according to clause 23, wherein
an association relationship between the electronic business card and the member having acquired the electronic business card is visible to the any member; and a request object of the permission acquiring request is designated by the any member as the member having acquired the electronic business card; or
the association relationship is invisible to the any member; the forwarding the permission acquiring request to the member having acquired the electronic business cards when a permission acquiring request for the electronic business card initiated by the any member is received comprises: when a permission acquiring request for the electronic business card initiated by the any member is received, forwarding, according to the association relationship, the permission acquiring request to the member having acquired the electronic business card.

Clause 25. An electronic business card management method, comprising:
determining a selected electronic business card; and
displaying, on a content display interface of the electronic business card, personal introduction information of a target user corresponding to the electronic business card and organization introduction information of an organization with which the target user is affiliated.

Clause 26. The method according to clause 25, wherein the method further comprises:
switching, according to an operation of triggering the organization introduction information, to an organization homepage interface corresponding to the organization with which the target user is affiliated.

Clause 27. The method according to clause 26, wherein the organization introduction information comprises brief introduction information of the organization with which the target user is affiliated, and the organization homepage interface comprises detailed introduction information of the organization with which the target user is affiliated.

Clause 28. The method according to clause 25, wherein the electronic business card is acquired using any one of the following manners:
receiving an electronic business card proactively sent by an adjacent electronic device;
proactively sending to the adjacent electronic device an electronic business card of a local user, and receiving an electronic business card returned by the adjacent electronic device;
based on a verification code related to the adjacent electronic device, acquiring, from the adjacent electronic device or a server, an electronic business card of a user having logged onto the adjacent electronic device; and
creating a corresponding electronic business card according to a scanning result of information on a paper business card.

Clause 29. The method according to clause 25, further comprising:
displaying, on the content display interface of the electronic business card, corresponding scene information when the electronic business card is acquired.

Clause 30. The method according to clause 29, wherein the scene information comprises at least one of the following: a time, a location, and a pre-planned event related to the time and/or the location.

Clause 31. The method according to clause 25, further comprising:
displaying, on the content display interface of the electronic business card, a characteristic label and/or annotation information marked by a local user for the electronic business card.

Clause 32. The method according to clause 25, wherein after the electronic business card is acquired by a specific member in an organization with which a local user is affiliated, the electronic business card is associated with the organization with which the local user is affiliated; and the method further comprises: initiating a permission acquiring request for the electronic business card to a server, so that the server forwards the permission acquiring request to the specific member according to an association relationship between the specific member and the electronic business card, such that the specific member determines whether to grant the local user an access permission for the electronic business card; and
the displaying personal introduction information of the target user corresponding to the electronic business card comprises: when the local user has the access permission, displaying all content of the personal introduction information; and when the local user does not have the access permission, displaying some of the content of the personal introduction information, such that at least some content of the personal introduction information is in a hidden state.

Clause 33. An electronic business card management method, comprising:
receiving, from a first user, a business card access request, wherein the business card access request is initiated for an electronic business card shared by a second user; and
returning to the first user content of the electronic business card, wherein when the first user has not acquired an access permission granted by the second user, at least some of the content of the electronic business card is in a state hidden from the first user.

Clause 34. The method according to clause 33, further comprising:
receiving a permission acquiring request for the electronic business card initiated by the first user;
forwarding the permission acquiring request to the second user according to a sharing relationship between the second user and the electronic business card; and
granting the first user the access permission according to a confirmation message returned by the second user, such that the hidden state is no longer concealed from said user.

Clause 35. An electronic business card management apparatus, comprising:
a business card acquiring unit, configured to acquire an electronic business card;
a scene determination unit, configured to determine corresponding scene information when the electronic business card is acquired; and
a first association unit, configured to associate the electronic business card with the corresponding scene information.

Clause 36. The apparatus according to clause 35, wherein the business card acquiring unit is specifically configured to implement at least one of the following:
receiving an electronic business card proactively sent by an adjacent electronic device;
proactively sending to the adjacent electronic device an electronic business card of a local user, and receiving an electronic business card returned by the adjacent electronic device;
based on a verification code related to the adjacent electronic device, acquiring, from the adjacent electronic device or a server, an electronic business card of a user having logged onto the adjacent electronic device; and
creating a corresponding electronic business card according to a scanning result of information on a paper business card.

Clause 37. The apparatus according to clause 35, wherein the scene information comprises at least one of the following: a time, a location, and a pre-planned event related to the time and/or the location.

Clause 38. The apparatus according to clause 35, further comprising:
a function providing unit, configured to provide a local user with a unified marking function for all electronic business cards covered by the scene information;
an information determination unit, configured to determine a unified characteristic label and/or unified annotation information set by the local user; and
an information association unit, configured to associate the unified characteristic label and/or the unified annotation information with all the electronic business cards covered by the scene information.

Clause 39. The apparatus according to clause 35, further comprising:
a classification and display unit, configured to classify and display acquired electronic business cards according to the scene information.

Clause 40. The apparatus according to clause 35, further comprising:
an event recording unit, configured to record interaction events between a local user and a target user corresponding to the electronic business card; and
an arrange and display unit, configured to arrange and display on a display interface corresponding to the electronic business card the interaction events in accordance with a time sequence of occurrences.

Clause 41. The apparatus according to clause 40, wherein the interaction event comprises at least one of the following: a business card transferring event, a communication event, or a visit event.

Clause 42. The apparatus according to clause 35, further comprising:
a data update unit, configured to update data of the electronic business card according to business card updating data sent by a server, wherein
the business card updating data is related to a business card updating operation on the electronic business card performed by the target user.

Clause 43. The apparatus according to clause 35, further comprising:
a link generation unit, configured to generate a sharing link of the electronic business card; and
a sharing unit, configured to send to a target recipient user the sharing link or sharing content representing the sharing link.

Clause 44. The apparatus according to clause 35, wherein the electronic business card comprises private content, wherein the private content is hidden when an electronic business card of a local user is not sent to a target user corresponding to the electronic business card, and is displayed when the electronic business card of the local user is sent to the target user.

Clause 45. The apparatus according to clause 35, further comprising:
an identifier providing unit, configured to provide a local user with communication identifiers of all electronic business cards covered by the scene information; and
a group creation unit, configured to create a corresponding communication group according to an operation of the local user triggering the communication identifiers, wherein members in the communication group comprise the local user and a target user corresponding to an electronic business card related to the scene information.

Clause 46. The apparatus according to clause 35, further comprising:
a second association unit, configured to associate the electronic business card and the corresponding scene information with an organization with which a local user is affiliated.

Clause 47. The apparatus according to clause 46, further comprising:
a request receiving unit, configured to receive a permission acquiring request for the electronic business card initiated by any member in the organization, wherein when the any member has not acquired an access permission for the electronic business card, at least some content of the electronic business card is in a state hidden from the any member; and
a message returning unit, configured to return a confirmation message for the permission acquiring request according to a confirmation operation of the local user, such that the access permission for the electronic business card is granted to the any member, and the hidden state is no longer concealed from the any member.

Clause 48. The apparatus according to clause 47, wherein
an association relationship between the local user and the electronic business card is visible to the any member; and the request receiving unit is specifically configured to: receive the permission acquiring request for the electronic business card initiated by the any member to the local user; or
the association relationship is invisible to the any member; and the request receiving unit is specifically configured to: receive, from a server, the permission acquiring request, wherein after the permission acquiring request is sent by the any member to the server, the server forwards the permission acquiring request to the local user according to the association relationship.

Clause 49. An electronic business card management apparatus, comprising:
a business card determination unit, configured to determine electronic business cards acquired by members in an organization;
a relationship recording unit, configured to record a relationship between the electronic business cards and the organization; and
a first permission granting unit, configured to set access permissions for the members in the organization for the electronic business cards according to the relationship.

Clause 50. The apparatus according to clause 49, further comprising:
a scene recording unit, configured to record corresponding scene information when the electronic business cards are acquired, wherein
the scene information is used to classify and display the electronic business cards.

Clause 51. The apparatus according to clause 50, wherein the scene information comprises at least one of the following: a time, a location, and a pre-planned event related to the time and/or the location.

Clause 52. The apparatus according to clause 49, further comprising:
a data update unit, configured to update data of the electronic business cards according to a business card updating operation performed on the electronic business cards by a target user.

Clause 53. The apparatus according to clause 49, wherein the first permission granting unit is specifically configured to:
when any user joins the organization, grant the any user the access permission for the electronic business cards; and
when the any user leaves the organization, cancel the access permissions of the any user for the electronic business cards.

Clause 54. The apparatus according to clause 49, wherein
the relationship recording unit is specifically configured to: record a mapping relationship between the electronic business cards and an organization node corresponding to the member having acquired the electronic business cards in an organizational structure of the organization; and
the first permission granting unit is specifically configured to: grant a member corresponding to the association node in the organization access permissions for the electronic business cards.

Clause 55. The apparatus according to clause 54, further comprising:
a business card pushing unit, configured to, when the member corresponding to the organization node in the organization is changed, push an electronic business card of a member after the change to target users corresponding to the electronic business cards.

Clause 56. The apparatus according to clause 54, further comprising:
a node determination unit, configured to determine an association node related to the organization node in the organizational structure of the organization; and
a second permission granting unit, configured to grant the member corresponding to the association node in the organization the access permission for the electronic business card.

Clause 57. The apparatus according to clause 49, wherein when any member in the organization has not acquired the access permissions for the electronic business cards, hiding at least some content of the electronic business card from the any member; and the apparatus further comprises:
a request forwarding unit, configured to forward the permission acquiring request to the member having acquired the electronic business card when a permission acquiring request for the electronic business card initiated by the any member is received; and
a third permission granting unit, configured to grant the any member the access permission for the electronic business card according to a confirmation message returned by the member having acquired the electronic business card.

Clause 58. The apparatus according to clause 57, wherein
an association relationship between the electronic business card and the member having acquired the electronic business card is visible to the any member; and a request object of the permission acquiring request is designated by the any member as the member having acquired the electronic business card; or
the association relationship is invisible to the any member; and the request forwarding unit is specifically configured to: when a permission acquiring request for the electronic business card initiated by the any member is received, forward, according to the association relationship, the permission acquiring request to the member having acquired the electronic business card.

Clause 59. An electronic business card management apparatus, comprising:
a business card determination unit, configured to determine a selected electronic business card; and
a first display unit, configured to display, on a content display interface of the electronic business card, personal introduction information of a target user corresponding to the electronic business card and organization introduction information of an organization with which the target user is affiliated.

Clause 60. The apparatus according to clause 59, further comprising:
an interface switching unit, configured to switch, according to an operation of triggering the organization introduction information, to an organization homepage interface corresponding to the organization with which the target user is affiliated.

Clause 61. The apparatus according to clause 60, wherein the organization introduction information comprises brief introduction information of the organization with which the target user is affiliated, and the organization homepage interface comprises detailed introduction information of the organization with which the target user is affiliated.

Clause 62. The apparatus according to clause 59, wherein the electronic business card is acquired using any one of the following manners:
receiving an electronic business card proactively sent by an adjacent electronic device;
proactively sending to the adjacent electronic device an electronic business card of a local user, and receiving an electronic business card returned by the adjacent electronic device;
based on a verification code related to the adjacent electronic device, acquiring, from the adjacent electronic device or a server, an electronic business card of a user having logged onto the adjacent electronic device; and
creating a corresponding electronic business card according to a scanning result of information on a paper business card.

Clause 63. The apparatus according to clause 59, further comprising:
a second display unit, configured to display, on the content display interface of the electronic business card, corresponding scene information when the electronic business card is acquired.

Clause 64. The apparatus according to clause 63, wherein the scene information comprises at least one of the following: a time, a location, and a pre-planned event related to the time and/or the location.

Clause 65. The apparatus according to clause 59, further comprising:
a third display unit, configured to display, on the content display interface of the electronic business card, a characteristic label and/or annotation information marked by a local user for the electronic business card.

Clause 66. The apparatus according to clause 59, wherein after the electronic business card is acquired by a specific member in an organization with which a local user is affiliated, the electronic business card is associated with the organization with which the local user is affiliated; and the apparatus further comprises: a request initiation unit, configured to initiate a permission acquiring request for the electronic business card to a server, so that the server forwards the permission acquiring request to the specific member according to an association relationship between the specific member and the electronic business card, such that the specific member determines whether to grant the local user an access permission for the electronic business card; and
the first display unit is specifically configured to: when the local user has acquired the access permission, display all content of the personal introduction information; and when the local user has not acquired the access permission, display some of the content of the personal introduction information, such that at least some content of the personal introduction information is in a hidden state.

Clause 67. An electronic business card management apparatus, comprising:
a first receiving unit, configured to receive, from a first user, a business card access request, wherein the business card access request is initiated with regard to an electronic business card shared by a second user; and
a returning unit, configured to return to the first user content of the electronic business card, wherein when the first user has not acquired an access permission granted by the second user, at least some of the content of the electronic business card is in a state hidden from the first user.

Clause 68. The apparatus according to clause 67, further comprising:
a second receiving unit, configured to receive a permission acquiring request for the electronic business card initiated by the first user;
a forwarding unit, configured to forward the permission acquiring request to the second user according to a sharing relationship between the second user and the electronic business card; and
a granting unit, configured to grant the first user the access permission according to a confirmation message returned by the second user, such that the hidden state is no longer concealed from the user.

What is claimed is:

1. A method comprising:
acquiring an electronic business card;
determining corresponding scene information when the electronic business card is acquired; and
associating the electronic business card with the corresponding scene information.

2. The method according to claim 1, wherein the acquiring the electronic business card comprises:
receiving an electronic business card proactively sent by an adjacent electronic device;
proactively sending to the adjacent electronic device an electronic business card of a local user, and receiving an electronic business card returned by the adjacent electronic device;
acquiring, from the adjacent electronic device or a server based on a verification code related to the adjacent electronic device, an electronic business card of a user having logged onto the adjacent electronic device; or
creating a corresponding electronic business card according to a scanning result of information on a paper business card.

3. The method according to claim 1, wherein the scene information comprises at least one of the following: a time, a location, and a pre-planned event related to the time or the location.

4. The method according to claim 1, further comprising:
providing a local user with a unified marking function for the electronic business card covered by the scene information;
determining a unified characteristic label or unified annotation information set by the local user; and
associating the unified characteristic label or the unified annotation information with another electronic business card covered by the scene information.

5. The method according to claim 1, further comprising:
classifying and displaying the acquired electronic business card in accordance with the scene information.

6. The method according to claim 1, further comprising:
recording an interaction event between a local user and a target user corresponding to the electronic business card; and
arranging and displaying on a display interface corresponding to the electronic business card the interaction event in accordance with a time sequence of occurrences.

7. The method according to claim 6, wherein the interaction events comprise at least one of the following: a business card transferring event, a communication event, or a visit event.

8. The method according to claim 1, further comprising:
updating data of the electronic business card according to business card updating data sent by a server, wherein
the business card updating data is related to a business card updating operation on the electronic business card performed by a target user.

9. The method according to claim 1, further comprising:
generating a sharing link of the electronic business card; and
sending to a target recipient user the sharing link or a sharing content representing the sharing link.

10. The method according to claim 1, wherein the electronic business card comprises a private content, wherein the private content is hidden when the electronic business card of a local user is not sent to a target user corresponding to the electronic business card, and is displayed when the electronic business card of the local user is sent to the target user.

11. The method according to claim 1, further comprising:
providing a local user with communication identifiers for multiple electronic business cards covered by the scene information; and
creating a corresponding communication group according to an operation of the local user triggering the communication identifiers, wherein members in the communication group comprise the local user and a target user corresponding to the electronic business card related to the scene information.

12. The method according to claim 1, further comprising:
associating the electronic business card and the corresponding scene information with an organization with which a local user is affiliated.

13. The method according to claim 12, further comprising:
receiving a permission acquiring request for the electronic business card initiated by a member in the organization, wherein when the member has not acquired an access permission for the electronic business card, at least some content of the electronic business card is in a state hidden from the any member; and
returning a confirmation message for the permission acquiring request according to a confirmation operation of the local user, such that the access permission for the electronic business card is granted to the any member, and the hidden state is no longer concealed from the any member.

14. The method according to claim 13, wherein:
an association relationship between the local user and the electronic business card is visible to the member; and the receiving the permission acquiring request for the electronic business card initiated by the member in the organization comprises: receiving the permission acquiring request for the electronic business card initiated by the any member to the local user; or
the association relationship is invisible to the member; and the receiving the permission acquiring request for the electronic business card initiated by the member in the organization comprises: receiving, from a server, the permission acquiring request, wherein after the permission acquiring request is sent by the any member to the server, the server forwards the permission acquiring request to the local user according to the association relationship.

15. A device comprising:
one or more processors; and
one or more computer-readable media storing thereon computer-readable instructions that, when executed by the one or more processors, cause the one or more processors to perform acts comprising:
determining an electronic business card acquired by a member in an organization;
recording a relationship between the electronic business card and the organization; and
setting an access permission for the member in the organization for the electronic business card according to the relationship.

16. The device according to claim 15, wherein the acts further comprise:
recording corresponding scene information when the electronic business card is acquired, wherein
the scene information is used to classify and display the electronic business card.

17. The device according to claim 16, wherein the scene information comprises at least one of the following: a time, a location, and a pre-planned event related to the time or the location.

18. The device according to claim 15, wherein the acts further comprise:
updating data of the electronic business card according to a business card updating operation performed on the electronic business card by a target user.

19. The device according to claim 15, wherein the setting the access permission of the member in the organization for the electronic business card according to the relationship comprises:
when a user joins the organization, granting the user the access permission for the electronic business cards; and
when the user leaves the organization, canceling the access permission of the user for the electronic business card.

20. One or more computer-readable media storing thereon computer-readable instructions that, when executed by one or more processors, cause the one or more processors to perform acts comprising:
determining a selected electronic business card; and
displaying, on a content display interface of the electronic business card, personal introduction information of a target user corresponding to the electronic business card and organization introduction information of an organization with which the target user is affiliated.
